(19) United States
(12) Patent Application Publication
(10) Pub. No.: US 2026/0234437 A1
(43) Pub. Date: Aug. 13, 2026

(54) METHOD FOR FORMING MULTILAYER COATING FILM AND CLEAR COATING USED FOR PRODUCING MULTILAYER COATING FILM

(71) Applicant: BASF COATINGS GMBH, Muenster (DE)

(72) Inventors: Etsumi ITO, Kanagawa (JP); Hisayuki NAKASHIMA, Kanagawa (JP); Takeshi TSUNODA, Kanagawa (JP); Hideki YAMASHITA, Kanagawa (JP)

(21) Appl. No.: 19/145,685

(22) PCT Filed: Dec. 18, 2023
(86) PCT No.: PCT/IB2023/000781

§ 371 Date: Jul. 3, 2025

(30) Foreign Application Priority Data
Jan. 20, 2023 (JP) 2023-007416

(51) Int. Cl. C09D 175/14

(52) U.S. Cl. CPC C09D 175/14

(57) ABSTRACT

Disclosed herein are a method for forming a multilayer coating film having excellent coating film performance even when cured at low temperatures, and a clear coating composition used in the same.

The method for forming a multilayer coating film includes:
a step (1) of coating an aqueous first colored coating composition (BC1) onto an object to be coated,
a step (2) of coating the aqueous one-part type second colored coating composition (BC2) onto that coating film,
a step (3) of coating a clear coating composition (CC) onto that coating film, and
a step (4) of simultaneously curing the uncured first colored coating film, the uncured second colored coating film, and the uncured clear coating film, formed in steps (1) to (3), by heating at 70 to 100° C.; and the clear coating composition (CC).

### TECHNICAL FIELD

The present invention relates to a method for forming a multilayer coating film and a clear coating composition used in the same.

### BACKGROUND ART

Multilayer coating films are formed on objects to be coated, such as automobile bodies, in order to protect the objects to be coated and, at the same time, provide an attractive appearance. For automobile body coatings of this sort, the three-coat-one-bake method for forming multilayer coatings is becoming mainstream, in which a first aqueous base coating composition, a second aqueous base coating composition, and a clear coating composition are sequentially applied, and then these three layers are simultaneously baked and cured. In recent years, with a view to energy savings and environmental compliance, there has been a demand for reduction of the temperature at which baking is performed after the three layers are applied. However, when curing by low-temperature baking is performed using conventional coating compositions, it is difficult to obtain a fully cured coating film.

Furthermore, at automobile production sites, as a part of control for uniformly producing products with for excellent quality, the condition of multilayer coating films that have be obtained is inspected, and a polishing process and/or a recoating process is performed, depending on the defect conditions. In the recoating process, repair is performed by forming a laminate of multiple multilayer coatings films, by once again layering on the first multilayer coating that has been provided on the object to be coated, with a subsequent multilayer coating film, using the three-coat-one-bake method. For this reason, it is necessary that the clear coating film of the first multilayer coating film and the first aqueous base coat layer of the next multilayer coating film have excellent adhesion, which is to say, excellent recoat adhesion.

Under these circumstances, a method has been disclosed for improving the performance of a clear coating film and lowering the baking temperature for a multilayer coating film including the same by adding an unsaturated fatty acid ester polyol to a clear coating composition (Patent Document 1). Furthermore, a method has been disclosed for improving the adhesion between multilayer coating films in low-temperature baking by using an aliphatic triisocyanate with a molecular weight within the range of 200 to 350 as a portion of the curing agent for a clear coating composition and allowing the aliphatic triisocyanate to penetrate into the base coating layer during baking (Patent Document 2).

### PRIOR ART DOCUMENTS

### Patent Documents

Patent Document 1 JP 2016-188387 A
Patent Document 2 JP 7043621 B

### SUMMARY OF THE INVENTION

### Problems to be Solved by the Invention

However, even if an unsaturated fatty acid ester polyol is added to a clear coating composition and cured at a low temperature by the method of Patent Document 1, sufficient recoat adhesion may not be obtained.

Furthermore, even when low-molecular-weight aliphatic triisocyanate was used as a portion of the curing agent in a clear coating composition and a multilayer coating film was cured at a low temperature, as in Patent Document 2, it could not necessarily be said that the recoat adhesion was sufficient. Furthermore, it may not be possible to satisfy coating film performance such as gasoline resistance, chipping resistance, and water resistance, in a well-balanced manner.

Meanwhile, in view of the conventional art described above, an object of the present invention is to provide a method for forming a multilayer coating film that has excellent recoat adhesion, even when cured at low temperatures, and maintains coating film performance such as gasoline resistance, chipping resistance, and water resistance.

Furthermore, an object of the present invention is to provide a clear coating composition that can be used to form a multilayer coating film formed by a three-coat-one-bake method, and can form a multilayer coating film that has excellent recoat adhesion even when cured at low temperatures, and that maintains coating film performance such as gasoline resistance, chipping resistance, and water resistance.

### Means for Solving the Problems

As a result of intensive research by the present inventors, it was found that the aforementioned object is achieved by a method for forming a multilayer coating film, comprising:
a step (1) of coating an aqueous first colored coating composition (BC1) onto an object to be coated to form an uncured first colored coating film;
a step (2) of coating an aqueous one-part type second colored coating composition (BC2) on the uncured first colored coating film obtained in step (1) to form an uncured second colored coating film; and
a step (3) of coating a clear coating composition (CC) onto the uncured second colored coating film obtained in step (2) to form an uncured clear coating film, wherein
   the clear coating composition (CC) includes
a hydroxyl group-containing acrylic resin (A1),
an isocyanate curing agent (A2), and
an unsaturated fatty acid ester polyol (D) having at least two hydroxyl groups in one molecule,
and the distance Ra between the solubility parameters in Hansen space of the hydroxyl group-containing acrylic resin (A1) and the solubility parameters in Hansen space of the unsaturated fatty acid ester polyol (D) is 4.0 or less;
and a step (4) of simultaneously curing the uncured first colored coating film, the uncured second colored coating film, and the uncured clear coating film, formed in steps (1) to (3), by heating at 70 to 100° C.

In the method of the present invention, the hydroxyl value of the hydroxyl group-containing acrylic resin (A1) is preferably within the range of 80 to 200 mg KOH/g.

In the method of the present invention, the hydroxyl group-containing acrylic resin (A1) preferably has a mass average molecular weight of 3,000 to 30,000.

In the method of the present invention, the clear coating composition (CC) preferably includes a urethane curing catalyst (E).

In the method of the present invention, the dry film thickness of the first colored coating film is preferably 4 to 30 μm.

Furthermore, the present invention achieves the aforementioned object by a clear coating composition (CC) for forming a clear coating film used for forming a multilayer coating film by simultaneously curing
an uncured first colored coating film formed from an aqueous first colored coating composition (BC1),
an uncured second colored coating film formed from an aqueous one-part type second colored coating composition (BC2) provided on the uncured first colored coating film,
and an uncured clear coating film provided on the uncured second colored coating film, wherein:
the clear coating composition (CC) includes
a hydroxyl group-containing acrylic resin (A1),
an isocyanate curing agent (A2), and
an unsaturated fatty acid ester polyol (D) having at least two hydroxyl groups in one molecule;
the distance Ra between the solubility parameters in Hansen space of the hydroxyl group-containing acrylic resin (A1) and the solubility parameters in Hansen space of the unsaturated fatty acid ester polyol (D) is 4.0 or less; and
the uncured first colored coating film, the uncured second colored coating film, and the uncured clear coating film are cured by heating at 70 to 100° C.

In the present invention, the clear coating composition is preferably such that the amount (solids content) of the unsaturated fatty acid ester polyol (D) blended is 3 to 20 mass %, with respect to the total mass of the solids contents of all of the resin components included in the clear coating composition (CC).

In the present invention, the aqueous first colored coating composition (BC1) preferably includes a carboxyl group-containing resin (B1) and a carbodiimide group-containing curing agent (B2),
and the clear coating composition (CC) preferably includes isocyanate groups in the isocyanate curing agent (A2) at a ratio of 0.8 to 1.5 equivalents per 1 equivalent of hydroxyl groups in the hydroxyl group-containing acrylic resin (A1).

Further, in the present invention, it is preferred that the clear coating composition (CC) includes isocyanate groups in the isocyanate curing agent (A2) at a ratio of 1.5 to 3.0 equivalents per 1 equivalent of hydroxyl groups in the hydroxyl group-containing acrylic resin (A1) and the isocyanate curing agent (A2) includes a diisocyanate dimer (A2-1) and a diisocyanate trimer or higher compound (A2-2) at a solids-content mass ratio within the range of 10/90 to 40/60.

In the present invention, the clear coating composition (CC) preferably includes a 3-isocyanatopropyltrialkoxysilane compound (A3), and the amount (solids content) of the 3-isocyanatopropyltrialkoxysilane compound blended is 2 to 50 mass %, with respect to the total mass of the solids content of all of the resin components included in the clear coating composition (CC).

### Effects of the Invention

The present invention makes possible a method for forming a multilayer coating film that can be cured at a low temperature of 70 to 100° C. and has excellent recoat adhesion. Further, the clear coating composition of the present invention is suitably used for forming a multilayer coating film by curing at a low temperature in a three-coat-one-bake method, and the resulting clear coating film has excellent recoat adhesion. Furthermore, the method for forming a multilayer coating film of the present invention and the multilayer coating film obtained from the clear coating composition of the present invention are at least equivalent or better than conventional multilayer coating films with regard to coating film performance such as gasoline resistance, chipping resistance, and water resistance.

### BRIEF DESCRIPTION OF THE DRAWINGS

FIGS. 1 (a) and (b) are views describing the method for producing a multilayer coating film and a clear coating composition used in the same, according to a first embodiment of the present invention.

FIGS. 2 (a) and (b) are views describing the method for producing a multilayer coating film and a clear coating composition used in the same, according to a second embodiment of the present invention.

FIGS. 3 (a) and (b) are views describing the method for producing a multilayer coating film and a clear coating composition used in the same, according to a third embodiment of the present invention.

FIGS. 4 (a) and (b) are views describing the method for producing a multilayer coating film and a clear coating composition used in the same, according to a fourth embodiment of the present invention.

### MODES FOR CARRYING OUT THE INVENTION

The method for forming a multilayer coating film of the present invention includes:
a step (1) of coating an aqueous first colored coating composition (BC1) onto an object to be coated to form an uncured first colored coating film;
a step (2) of coating an aqueous one-part type second colored coating composition (BC2) on the uncured first colored coating film obtained in step (1) to form an uncured second colored coating film;
a step (3) of coating a clear coating composition (CC) on the uncured second colored coating film obtained in step (2) to form an uncured clear coating film; and
a step (4) of simultaneously curing the uncured first colored coating film, the uncured second colored coating film, and the uncured clear coating film, formed in steps (1) to (3), by heating at 70 to 100° C.

Furthermore, the clear coating composition (CC) used in the present invention comprises a hydroxyl group-containing acrylic resin (A1), an isocyanate curing agent (A2), and an unsaturated fatty acid ester polyol (D) having at least two hydroxyl groups in one molecule. Further, in the clear coating composition, the distance Ra between the solubility parameters in Hansen space of the hydroxyl group-containing acrylic resin (A1) and the solubility parameters in Hansen space of the unsaturated fatty acid ester polyol (D) is 4.0 or less.

Further, a method for producing a multilayer coating film according to an embodiment of the present invention will be described.

### [Step (1)]

In the method for forming a multilayer coating film of the present invention, in step (1), an aqueous first colored coating composition (BC1) including a coloring pigment is coated onto an object to be coated, to form an uncured first colored coating film layer.

### Object to be Coated

There are no particular restrictions on the object to be coated to which the method for forming a multilayer coating film of the present invention can be applied, and examples include components made of metals such as iron, zinc, aluminum, and magnesium, components made of alloys of these metals, components on which plating or vapor-deposition has been performed with these metals, components made from glass, plastics, foams of various materials, and the like, among which, steel materials and plastic materials constituting automobile bodies are preferred. These components can be subjected to appropriate treatments such as degreasing and surface treatment, as needed.

Furthermore, in the present invention, products in which an undercoat film has been formed on the aforementioned components can also be used as objects to be coated. Undercoat films are applied to the surfaces of components in order to hide the surface of the component or provide corrosion resistance, rust prevention, adhesion, or the like, to the component, and can be formed by coating with an undercoat coating and curing or drying. These undercoat coatings are not particularly limited, and undercoat coatings that are known per se, such as electrodeposition coatings, solvent-based primers, and water-based primers can be used.

Furthermore, in the present invention, the object to be coated can be a product in a state in which at least one multilayer coating has been performed on the aforementioned component, in which a treatment has optionally been performed on metal, glass, or plastic. Recoating refers to a process of making a further multilayer coating film by performing step (1) to step (4) on an object to be coated that includes such a multilayer coating film, for the purpose of repair.

### Aqueous First Colored Coating Composition (BC1)

The aqueous first colored coating composition (BC1) used in step (1) of the method for forming a multilayer coating film of the present invention includes a resin component and a coloring pigment.

The resin component of the first aqueous colored coating composition (BC1) used in the present invention is not particularly limited, as long as it is a component that can form an aqueous colored coating composition, and may be a thermosetting resin that forms a coating film as a result of a crosslinking reaction that proceeds with heating, after coating, or may be a thermoplastic resin that forms a coating film by volatilization of a solvent.

In the present invention, “aqueous” means that the base resin, crosslinking agent, and the like can be stably dissolved or dispersed in water or a mixture of water and an organic solvent.

For example, a thermosetting resin composition comprising a base resin and a crosslinking agent can be used as the thermosetting resin composition. The content of the crosslinking agent in the resin composition (base resin+crosslinking agent) is not particularly limited, but it is preferably 0 to 50 parts by mass, more preferably 5 to 45 parts by mass, and particularly preferably 10 to 40 parts by mass, with respect to 100 parts by mass of the total amount of the non-volatile components in the resin composition.

The base resin of the thermosetting resin composition is not particularly limited as long as it is water-soluble or water-dispersible, but examples include acrylic resin, polyester resin, polyurethane resin, polyurea resin, acrylic urethane resin, polyurethane-polyurea resin, and the like. Further, the base resin may consist of partially crosslinked particles, or the particles may be core/shell particles comprising an inside (core part) and an outside (shell part). Examples of particulate base resins include polyurethane-polyurea particles, urethane core/acrylic shell particles, and acrylic core/urethane shell particles. Note that, if the base resin particles are partially crosslinked, that portion will serve as a portion that is insoluble in organic solvents (gel part), and therefore, the gel fraction, which is a value indicating the ratio of the gel part in the solids content of the base resin particle, can be measured. Furthermore, it is preferable that the base resin has a hydroxyl group and/or a carboxyl group as a functional group. These base resins may be used alone or in combinations of two or more.

Examples of the curing agent for the thermosetting resin composition include amino resins, polyisocyanate compounds, blocked polyisocyanate compounds, and polycarbodiimide compounds. Among these, amino resins and polycarbodiimide compounds are particularly preferred. These curing agents may be used alone or in combinations of two or more.

Amino resin is a general term for resins resulting from adding formaldehyde to a compound containing an amino group and condensing. Examples of amino resins include melamine resin, urea resin, and guanamine resin, among which melamine resin is particularly preferred.

Melamine resins include partially or fully methylolated melamine resins obtained by reacting melamine with formaldehyde, partial or full alkyl ether type melamine resins obtained by partially or fully etherifying the methylol groups of the methylolated melamine resin with an alcohol component, imino group-containing melamine resins, and mixed melamine resins in which two or more melamine resins are mixed. Further, examples of alkyl ether type melamine resins include methylated melamine resin, butylated melamine resin, methyl/butyl mixed alkyl ether type melamine resin, and the like.

Examples of polyisocyanate compounds include: aliphatic diisocyanates such as hexamethylene diisocyanate, trimethyl hexamethylene diisocyanate, and dimer acid diisocyanate; aromatic diisocyanates such as xylylene diisocyanate (XDI), tolylene diisocyanate (TDI), and 4,4 -diphenylmethane diisocyanate (MDI); alicyclic diisocyanates such as isophorone diisocyanate, hydrogenated XDI, hydrogenated TDI, and hydrogenated MDI; and diisocyanate dimers and trimers such as uretdione, allophanate, adducts, biuret, and isocyanurate, or a compound comprising a greater number of diisocyanates.

Blocked polyisocyanate compounds include those in which the isocyanate groups of the aforementioned polyisocyanate compounds are blocked with alcohols such as butanol, oximes such as methyl ethyl ketoxime, lactams such as c-caprolactam, active methylenes such as malonic acid diesters and acetoacetic esters, imidazoles such as imidazole and 2-ethylimidazole, and phenols such as m-cresol.

Hydrophilic carbodiimide compounds are preferred as the polycarbodiimide compound. Examples of hydrophilic carbodiimide compounds include products of reacting a hydrophilising agent having an active hydrogen and a hydrophilic moiety with a reaction product obtained by reacting a polycarbodiimide compound containing at least two isocyanate groups in one molecule and a polyol having a hydroxyl group at the end of the molecule at a ratio such that the NCO/OH molar ratio exceeds 1.

In terms of the thermoplastic resin, thermoplastic resins such as acrylic resins, polyester resins, alkyd resins, urethane resins, polyolefin resins (including chlorinated and/or modified resins), and epoxy resins, having a mass average molecular weight of 30,000 or more can be used.

Coloring pigments in the aqueous first colored coating composition (BC1) used in the present invention include, for example: inorganic pigments such as titanium oxide pigments, iron oxide pigments, and complex oxide pigments such as titanium yellow; organic pigments such as azo-based pigments, quinacridone-based pigments, diketopyrrolopyrrole-based pigments, perylene-based pigments, perinone-based pigments, benzimidazolone-based pigments, isoindoline-based pigments, isoindolinone-based pigments, metal chelate azo-based pigments, phthalocyanine-based pigments, anthraquinone-based pigments, dioxazine-based pigments, threne-based pigments, and indigo-based pigments; carbon black pigments; and the like. These coloring pigments may be used alone or in combinations of two or more.

The total content of coloring pigments included in the aqueous first colored coating composition (BC1) used in the present invention is not particularly limited, but is preferably 10 to 200 parts by mass, more preferably 30 to 180 parts by mass, and particularly preferably 50 to 160 parts by mass, with respect to 100 parts by mass of the total amount of the non-volatile components of the resin used as the vehicle.

Furthermore, the aqueous first colored coating composition (BC1) used in the present invention may further contain a luster pigment. Examples of luster pigments include uncolored or colored aluminum pigments, vapor-deposited metal flake pigments, and light interference pigments in which a transparent or translucent base material is coated with a metal oxide. These luster pigments may be used alone or in combinations of two or more.

The total content of luster pigments included in the first aqueous colored coating composition used in the present invention is not particularly limited, but this is preferably 0 to 30.0 parts by mass, more preferably 0 to 25.0 parts by mass, and particularly preferably 0 to 20.0 parts by mass, with respect to 100 parts by mass of the total amount of the nonvolatile components of the resin used as the vehicle.

Various additives for coatings such as organic solvents and additives, such as surface conditioners, thickeners, rheology control agents, pigment dispersants, anti-settling agents, curing catalysts, defoamers, antioxidants, ultraviolet absorbers, as well as extender pigments can be suitably blended, as necessary, in the aqueous first colored coating composition (BC1) used in the present invention. In terms of organic solvents, for the production of the aqueous first colored coating composition (BC1), commonly used organic solvents such as: aromatic hydrocarbons such as toluene, xylene, and aromatic naphtha; ketones such as acetone, methyl ethyl ketone, and methyl amyl ketone; esters such as ethyl acetate, butyl acetate, 2-butoxyethyl acetate, pentyl acetate, and ethyl ethoxypropionate; alcohols such as isopropanol, butanol, and 2-butoxyethanol; ethers; aliphatic hydrocarbons including chlorinated hydrocarbons; or mixtures thereof can be mentioned.

The solids content of the aqueous first colored coating composition used in the present invention during coating is not particularly limited, but is preferably 10.0 to 50.0 mass %, and more preferably 20.0 to 30.0 mass %.

The aqueous first colored coating composition (BC1) used in the present invention can be applied by methods such as electrostatic coating, air spraying, and airless spraying. After coating with the aqueous first colored coating composition (BC1), heating (flash-off) may be performed at 70° C. to 80° C. for 3 to 5 minutes in order to evaporate the water contained in the first colored coating film or, rather than performing heating, it may simply be left at room temperature. If flash-off is performed, the temperature and time ranges are selected using the aforementioned ranges as a guide so that the coating film does not cure.

The cured film thickness of the aqueous first colored coating composition (BC1) is not particularly limited, but the film thickness after the heat treatment in step (4) described below (dry film thickness) is preferably 4 to 30 μm, more preferably the aqueous first colored coating composition (BC1) is coated to a thickness of 10 to 30 μm.

### [Step (2)]

An aqueous one-part type second colored coating composition (BC2) is coated onto the uncured first colored coating film obtained in step (1), for which flash-off has optionally been performed or which has been left at room temperature, to form an uncured second colored coating film.

### Aqueous One-Part Type Second Colored Coating Composition (BC2)

The aqueous one-part type second colored coating composition (BC2) used in step (2) includes a resin component and a coloring pigment.

The details of the resin component and the coloring pigment included in the aqueous one-part type second colored coating composition (BC2) are the same as those described for the aqueous first colored coating composition (BC1). However, since the aqueous one-part type second colored coating composition (BC2) is used as a one-part type composition, using a polyisocyanate compound or a polycarbodiimide compound as a curing agent is undesirable. The aqueous one-part type second colored coating composition (BC2) includes a resin component, and may include a luster pigment without containing a coloring pigment. The details of the amount of each component used in the aqueous one-part type second colored coating composition (BC2) are also the same as those described for the aqueous first colored coating composition (BC1). Furthermore, the resin component, coloring pigment, and luster pigment of the aqueous one-part type second colored coating composition (BC2) may be the same as each of the components of the corresponding aqueous first colored coating composition (BC1), or may be different.

In addition, the organic solvents, additives, and the like mentioned for the aqueous first colored coating composition (BC1) can also be used in the aqueous one-part type second colored coating composition (BC2).

The solids content of the aqueous one-part type second colored coating composition used in the present invention is not particularly limited, but is preferably 5.0 to 50.0 mass %, and more preferably 20.0 to 30.0 mass %.

As in the case of the aqueous first colored coating composition (BC1), application of the aqueous second one-part type colored coating composition (BC1) is also carried out by a method such as electrostatic coating, air spraying, airless spraying, or the like. Furthermore, generally, after the aqueous second colored coating composition (BC2) is applied, the flash-off described above is performed.

The aqueous one-part type second colored coating composition (BC2) is preferably applied so that the dry film thickness of the second colored coating film is, preferably, 3 to 20 μm, and more preferably, 5 to 15 μm. Note that the dry film thickness of the second colored coating film is the film thickness after the heat treatment in step (4) described below.

### [Step (3)]

In the method for forming a multilayer coating film of the present invention, as step (3), a clear coating composition (CC) is coated onto the uncured second colored coating film to form an uncured clear coating film.

### Clear Coating Composition (CC)

The clear coating composition (CC) used in the method for forming a multilayer coating film of the present invention includes a hydroxyl group-containing acrylic resin (A1), an isocyanate curing agent (A2), and an unsaturated fatty acid ester polyol (D) having at least two hydroxyl groups in one molecule.

### Hydroxyl Group-Containing Acrylic Resin (A1)

The hydroxyl group-containing acrylic resin (A) used in the present invention is a homopolymer obtained by homopolymerization of a hydroxyl group-containing acrylic monomer, or can be obtained in the form of a copolymer, by a known method such as radical copolymerization of a monomer mixture including a hydroxyl group-containing acrylic monomer.

Examples of hydroxyl group-containing acrylic monomers include esters such as 2-hydroxyethyl, 2-hydroxypropyl, 3-hydroxypropyl, or 4-hydroxybutyl acrylates or methacrylates, and ring-opening adducts of 2-hydroxyethyl acrylate or methacrylate with S-caprolactone, propylene oxide or ethylene oxide. These hydroxyl group-containing acrylic monomers may be used alone or in combinations of two or more.

Other monomers that can be copolymerized with the aforementioned hydroxyl group-containing acrylic monomers include acrylic acid or methacrylic acid, and methyl, ethyl, n-propyl, isopropyl, n-butyl, isobutyl, t-butyl, hexyl, cyclohexyl, 2-ethylhexyl, lauryl, and stearyl esters thereof and the like, as well as acrylonitrile, methacrylonitrile, acrylamide, methacrylamide, styrene, a-methylstyrene, maleic acid, vinyl acetate, and the like. These copolymerizable monomers may be used alone or in combinations of two or more with the hydroxyl group-containing acrylic monomer. The aforementioned polymerization is usually carried out using a known polymerization initiator.

The hydroxyl value of the hydroxyl group-containing acrylic resin (A) is determined by the content of the hydroxyl group-containing acrylic monomer in the monomers to be copolymerized. The hydroxyl value of the hydroxyl group-containing acrylic resin (A) used in the present invention is not particularly limited, but is preferably 80 to 200 mg KOH/g, and more preferably 80 to 190 mg KOH/g.

Furthermore, the mass average molecular weight of the hydroxyl group-containing acrylic resin (A) is determined by the reaction conditions during copolymerization. The mass average molecular weight of the hydroxyl group-containing acrylic resin (A) used in the present invention is not particularly limited, but is preferably from 2,000 to 30,000, more preferably from 3,000 to 25,000, and particularly preferably 4,000 to 20,000. Note that, in the present invention, the mass average molecular weight was measured by gel permeation chromatography (GPC) using tetrahydrofuran (THF) as the eluent, and values were found by converting data measured at a temperature of 40° C. and a flow rate of 1 m/min based on the mass average molecular weight of polystyrene. Here, a combination of TSKgel G2000HXL, G3000HXL, G4000HXL, and G5000HXL (trade names, made by Tosoh Corporation) was used for the columns in the gel permeation chromatography (GPC).

One type alone or a combination of two or more types may be used for the hydroxyl group-containing acrylic resin (A).

### Isocyanate Curing Agent (A2)

The isocyanate curing agent (A2) used in the present invention is not particularly limited as long as this is a product used in coating applications, and various isocyanate compounds such as aromatic, aliphatic, alicyclic, and the like can be used. Examples of such isocyanate curing agents (A2) include:
aliphatic diisocyanates such as hexamethylene diisocyanate, trimethyl hexamethylene diisocyanate, and dimer acid diisocyanate; aromatic diisocyanates such as xylylene diisocyanate (XDI), tolylene diisocyanate (TDI), and 4,4-diphenylmethane diisocyanate (MDI); alicyclic diisocyanates such as isophorone diisocyanate, hydrogenated XDI, hydrogenated TDI, hydrogenated MDI; and diisocyanate dimers and trimers such as uretdione, allophanate, adducts, biuret, and isocyanurate, or a compound comprising a greater number of diisocyanates. Furthermore, aliphatic triisocyanate compounds such as 2-isocyanatoethyl-2,6-diisocyanatecaproate (LTI) and 1,8-diisocyanato-4-isocyanatomethyloctane may be used. Further, some of these isocyanate groups may be modified with an amino group-containing silane coupling agent or the like. These isocyanate curing agents (A2) may be used alone or in combinations of two or more.

It is preferable that this be mixed so that the isocyanate groups of the isocyanate curing agent (A2) constitute a ratio of 0.8 to 3.0 equivalents, more preferably 0.9 to 3.0 equivalents, and particularly preferably 0.9 to 2.5 equivalents, with respect to 1 equivalent of hydroxyl groups in the hydroxyl group-containing acrylic resin (A) in the clear coating composition (CC) used in the present invention.

In the present invention, the clear coating composition (CC) includes a hydroxyl group-containing acrylic resin (A) and an isocyanate curing agent (A2) as essential resin components, and may also contain any other resin components. Examples of optional resin components include polyester resins, amino resins, and the like.

### Unsaturated Fatty Acid Ester Polyol (D)

The unsaturated fatty acid ester polyol having at least two hydroxyl groups in one molecule (D) (also referred to as the unsaturated fatty acid ester polyol (D)) used in the present invention is, for example, obtained by an esterification reaction of an unsaturated fatty acid with a polyol having at least three hydroxyl groups in the molecule.

Preferred examples of unsaturated fatty acids include oleic acid, linoleic acid, linolenic acid, ricinoleic acid, and combinations thereof, among which ricinoleic acid is particularly preferred. In addition, as long as the unsaturated fatty acid ester polyol (D) obtained has at least one unsaturated group per molecule, some of the unsaturated fatty acid can also be replaced by a saturated fatty acid. Preferred examples of saturated fatty acids include palmitic acid, stearic acid, 9,10-dihydroxystearic acid, 12-hydroxystearic acid, and combinations thereof.

Preferred examples of polyols having at least three hydroxy groups in one molecule include trimethylolpropane, ditrimethylolpropane, triethylolpropane, ditriethylolpropane, pentaerythritol, dipentaerythritol, tetrakis(2-hydroxyethyl) methane, glycerin, diglycerin, xylitol, sorbitol, galactitol, sucrose, combinations thereof, and the like, among which glycerin is particularly preferred.

Generally, the unsaturated fatty acid ester polyol (D) is an oligomeric molecule having a mass average molecular weight of, for example, 3,000 or less, and particularly 2,000 or less.

Regarding the hydroxyl group-containing acrylic resin (A1) and the unsaturated fatty acid ester polyol (D) used in the production of the clear coating composition (CC) of the present invention, the distance Ra between the solubility parameters in Hansen space of the hydroxyl group-containing acrylic resin (A1) and the solubility parameters in Hansen space of the unsaturated fatty acid ester polyol (D) is 4.0 or less, and preferably in the range of 0.5 to 3.5.

The aforementioned solubility parameters in Hansen space (HSP) are parameters for indicating the solubility of a substance developed by C. M. Hansen (C. M. Hansen, Hansen Solubility Parameters: A User's Handbook, 1999). In the present invention, the solubility parameters in Hansen space (HSP) are found using the group-contribution method proposed by D. W. van Krevelen and P. J. Hoftyzer (D. W. van Krevelen and P. J. Hoftyzer, Properties of Polymers 2nd Edition, 1976). Furthermore, the distance Ra between the solubility parameters in Hansen space of the hydroxyl group-containing acrylic resin (A1) and the solubility parameters in Hansen space of the unsaturated fatty acid ester polyol (D) was found according to the following formula (1), and was used as an indicator of the compatibility of the two.

$${R}_{a} = {[ 4 {( δ {D}_{2} - δ {D}_{1} )}^{2} + {( δ {P}_{2} - δ {P}_{1} )}^{2} + {( δ {H}_{2} - δ {H}_{1} )}^{2} ]}^{1 / 2} \qquad ( 1 )$$

Here, δD₁, δP₁, and δH₁ respectively represent the dispersion term, polarization term, and hydrogen bonding term of the solubility parameters in Hansen space of the hydroxyl group-containing acrylic resin (A1). Further, δD₂, δP₂, and δH₂ respectively represent the dispersion term, polarization term, and hydrogen bonding term of the solubility parameters in Hansen space of the unsaturated fatty acid ester polyol (D).

By selecting and using the hydroxyl group-containing acrylic resin (A1) and the unsaturated fatty acid ester polyol (D) so that the distance Ra between the solubility parameters in Hansen space according to the formula (1) is 4.0 or less, the compatibility between the hydroxyl group-containing acrylic resin (A1) and the unsaturated fatty acid ester polyol (D) in the clear coating composition (CC) is improved. As a result, the unsaturated fatty acid ester polyol (D) contributes to the curing reaction together with the hydroxyl group-containing acrylic resin (A1) while being well mixed with the hydroxyl group-containing acrylic resin (A1) within the clear coating film, the crosslinking density of the clear layer is increased, and a cured multilayer coating film can be obtained that satisfies coating film performance, such as recoat adhesion, gasoline resistance, chipping resistance, and water resistance, in a well-balanced manner.

The amount (solids content) of the unsaturated fatty acid ester polyol (D) blended is 1 to 20 mass %, and preferably 3 to 20 mass %, with respect to the total mass of the solids contents of all of the resin components included in the clear coating composition (CC). By setting the amount of the unsaturated fatty acid ester polyol (D) blended within the aforementioned range, the resulting cured multilayer coating film satisfies coating film performance, such as recoat adhesion, gasoline resistance, chipping resistance, and water resistance, in a well-balanced manner.

Further, the clear coating composition (CC) preferably includes a urethane curing catalyst (E).

### Urethane Curing Catalyst (E)

By adding a urethane curing catalyst (E) to the clear coating composition (CC), urethane bond formation reactions arising from the hydroxyl group-containing acrylic resin (A1), the isocyanate curing agent (A2), and the unsaturated fatty acid ester polyol (D) are promoted. Examples of the urethane curing catalyst (E) include bismuth-based compounds, aluminum-based compounds, tin-based compounds, zinc-based compounds, and the like.

Examples of the bismuth-based compounds include bismuth bis(acetylacetonate), bismuth 2-ethylhexanoate, bismuth neodecanoate, bismuth salicylate, and the like.

Examples of the aluminum-based compounds include aluminum tris(acetylacetonate), aluminum tris(ethyl acetoacetate), and the like.

Examples of the tin-based compounds include dimethyltin dilaurate, dibutyltin dilaurate, dimethyltin chloride, dibutyltin chloride, di-n-octyltin dilaurate, and the like.

Examples of the zinc-based compounds include zinc acetylacetonate, zinc propionate, zinc octoate, zinc 2-ethylhexanoate, zinc neodecanoate, zinc laurate, zinc stearate, zinc linoleate, zinc naphthenate, zinc benzoate, zinc salicylate, and the like.

The amount (solids content) of the urethane curing catalyst (E) blended is 2 mass % or less, and preferably 0.001 to 1.5 mass %, with respect to the total mass of the solids contents of all of the resin components included in the clear coating composition (CC).

Further, the clear coating composition (CC) used in the present invention may contain coloring pigments to the extent that transparency is not impaired. Examples of coloring pigments include: inorganic pigments such as titanium oxide pigments, iron oxide pigments, and complex oxide pigments such as titanium yellow; organic pigments such as azo pigments, quinacridone pigments, diketopyrrolopyrrole pigments, perylene pigments, perinone pigments, benzimidazolone pigments, isoindoline pigments, isoindolinone pigments, metal chelate azo pigments, phthalocyanine pigments, anthraquinone pigments, dioxazine pigments, threne pigments, and indigo pigments; carbon black pigments; and the like. These coloring pigments may be used alone or in combinations of two or more.

The total content of coloring pigments included in the clear coating composition (CC) used in the present invention is not particularly limited, but is preferably no greater than 10 mass %, and more preferably 0 to 5 mass %, with respect to the total mass of the solids contents of all of the resin components included in the clear coating composition (CC).

Various additives for coatings, such as solvents such as organic solvents, rheology control agents, pigment dispersants, anti-settling agents, defoamers, antioxidants, ultraviolet absorbers, as well as extender pigments can be further suitably blended, as necessary, in the clear coating composition (CC) used in the present invention. Examples of organic solvents include organic solvents commonly used in the production of clear coating compositions (CC), such as: aromatic hydrocarbons such as toluene, xylene, and aromatic naphtha; ketones such as acetone, methyl ethyl ketone and methyl amyl ketone; esters such as ethyl acetate, butyl acetate, 2-butoxyethyl acetate, pentyl acetate, and ethyl ethoxypropionate, ethers, aliphatic hydrocarbons including chlorinated hydrocarbons, or mixtures thereof. However, if alcohol is expected to interfere with the curing reaction, use thereof is not recommended.

The solids contents of the clear coating composition (CC) used in the present invention when coating is not particularly limited, but is preferably 30 to 70 mass %.

The clear coating composition (CC) used in the present invention can be applied by methods such as electrostatic coating, air spraying, and airless spraying. Generally, after a clear coating composition (CC) is applied, it is allowed to stand at room temperature for 5 to 20 minutes, and then heated and cured.

### [Step (4)]

In the method for forming a multilayer coating film of the present invention, as step (4), the uncured first colored coating film, the uncured second colored coating film, and the uncured clear coating film, which were formed in steps (1) to (3), are simultaneously cured by heating at 70 to 100° C., and preferably 80 to 100° C., so as to cure all of the first colored coating film, the second colored coating film, and the clear coating film, and form a multilayer coating film.

By setting the heating temperature to no lower than 70° C., the curing reaction can be sufficiently advanced, and by setting the heating temperature to no higher than 100° C., energy consumption can be limited. The heating time is generally preferably 5 to 60 minutes, more preferably 10 to 50 minutes, and particularly preferably 15 to 40 minutes. In the present invention, heating can be performed by known means, for example, a drying oven such as a hot air oven, an electric oven, an infrared induction heating oven, and the like can be used.

Note that, when the expression “multilayer coating film” is used alone in the present invention, it means a coating film that has been heated and cured by way of step (4), and is distinguished from the “uncured multilayer coating film” comprising the uncured first colored coating film, the uncured second colored coating film, and the uncured clear coating film, prior to step (4).

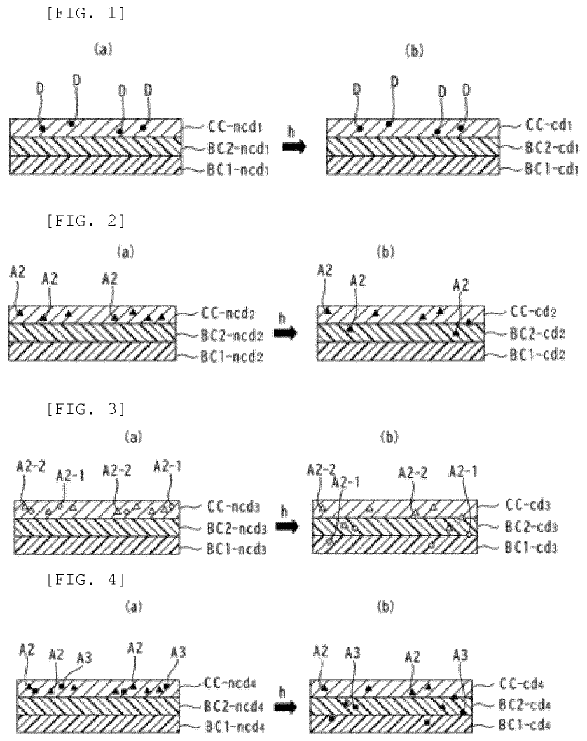

FIG. 1 to FIG. 4 show schematic cross-sectional views of the multilayer coating film of the present invention, and these will be used to describe further embodiments of the method for producing the multilayer coating film of the present invention or the multilayer coating film obtained thereby. Here, the clear coating films included in the multilayer coating films in FIG. 1 to FIG. 4 also correspond to embodiments of the clear coating composition of the present invention.

FIG. 1 shows a first embodiment. Specifically, FIG. 1 (a) shows an uncured multilayer coating obtained by sequentially coating, in accordance with steps (1) to (4), starting from the bottom, an uncured first colored coating film BC1-ncd1, an uncured second colored coating film BC2-ncd1, and an uncured clear coating film CC-ncd1 on an object to be coated (not shown), such as a metal sheet for an automobile body.

The uncured clear coating film CC-ncd1 located at the top layer in FIG. 1 (a) is obtained from the clear coating composition (CC) as previously described, and includes the hydroxyl group-containing acrylic resin (A1), the isocyanate curing agent (A2), and the unsaturated fatty acid ester polyol (D). Here, in the clear coating composition (CC), by using a hydroxyl group-containing acrylic resin (A1) and an unsaturated fatty acid ester polyol (D) selected so that the distance Ra between the solubility parameters in Hansen space of the hydroxyl group-containing acrylic resin (A1) and the solubility parameters in Hansen space of the unsaturated fatty acid ester polyol (D) is 4.0, and preferably 0.5 to 3.5, the compatibility of the hydroxyl group-containing acrylic resin (A1) and the unsaturated fatty acid ester polyol (D) is improved. Furthermore, in the clear coating composition (CC) of the present invention, the unsaturated fatty acid ester polyol (D) (indicated by ●) is uniformly present in the uncured clear coating film CC-ncd1.

In the first embodiment, it is preferable that this be mixed so that the isocyanate groups of the isocyanate curing agent (A2) constitute a ratio of 0.8 to 3.0 equivalents, more preferably 0.9 to 3.0 equivalents, and particularly preferably 0.9 to 2.5 equivalents, with respect to 1 equivalent of hydroxyl groups in the hydroxyl group-containing acrylic resin (A) in the clear coating composition (CC).

When heat treatment h, which is to say, baking, of the uncured multilayer coating film shown in FIG. 1(a) is started, the unsaturated fatty acid ester polyol (D) remains well mixed with the hydroxyl-group containing acrylic resin (A1) within the clear coating film and contributes to the curing reaction with the isocyanate curing agent (A2) together with the hydroxyl group-containing acrylic resin (A1). The multilayer coating film of the present invention including the cured clear coating film CC-cd1 having a high crosslinking density is thereby completed.

In addition to the matters described in the first embodiment, the second embodiment further specifies the aqueous first colored coating composition (BC1) and the clear coating composition (CC). Specifically, the second embodiment shown in FIG. 2 illustrates an example of a case in which, the aqueous first colored coating composition (BC1) includes a carboxyl group-containing resin (B1) and a carbodiimide group-containing curing agent (B2) (also referred to as a polycarbodiimide compound (B2)), and the clear coating composition (CC) includes isocyanate groups in the isocyanate curing agent (A2) at a ratio of 0.8 to 1.5 equivalents, and in particular 0.9 to 1.5 equivalents, with respect to 1 equivalent of the hydroxyl group in the hydroxyl group-containing acrylic resin (A1).

That is to say, in the multilayer coating film according to the second embodiment, the aqueous first colored coating composition (BC1) includes the carboxyl group-containing resin (B1) and the polycarbodiimide compound (B2) as the resin components mentioned in relation to step (1) described above. It is preferable that a composition 1 comprising the carboxyl group-containing resin (B1) and a composition 2 including a polycarbodiimide compound (B2) different therefrom are prepared in the form of a two-part type coating, and the two are mixed immediately before coating. The carboxyl group-containing resin (B1) and the polycarbodiimide compound (B2) are mixed and coated in step (1), and further reacted by heating in step (4).

Preferred examples of the carboxyl group-containing resin (B1) included in the aqueous first colored coating composition (BC1) include carboxyl group-containing polyester resin, carboxyl group-containing acrylic urethane resin, carboxyl group-containing polyurethane-polyurea particles, and carboxyl group-containing urethane core/acrylic shell type particles.

Further, preferred examples of the polycarbodiimide compound (B2) include products resulting from reacting a hydrophilizing agent having an active hydrogen and a hydrophilic moiety with a reaction product obtained by reacting a polycarbodiimide compound containing at least two isocyanate groups in one molecule and a polyol having a hydroxyl group at the end of the molecule, at a ratio such that the NCO/OH molar ratio exceeds 1.

As shown in FIG. 2(a), in the second embodiment, an uncured first colored coating film BC1-ncd2, an uncured second colored coating film BC2-ncd2, and an uncured clear coating film CC-ncd2 are sequentially layered. The uncured clear coating film CC-ncd2 includes an isocyanate curing agent (A2) (indicated by ▴). When the heat treatment h, which is to say, baking, of the uncured multilayer coating film in FIG. 2 (a), is started, due to the high polarity of the isocyanate curing agent (A2), some of the isocyanate curing agent (A2) migrates from the clear coating film, for which curing has not yet been completed, to the second colored coating film. Then, with the passage of heating time, the isocyanate curing agent (A2) in the clear coating film and in the second colored coating film reacts with the hydroxyl group-containing resin in each coating film and the uncured clear coating film CC-ncd2 and the uncured second colored coating film BC2-ncd2 are cured. Meanwhile, the uncured first colored coating film BC1-ncd2 is cured by reactions between carboxyl groups and carbodiimide groups within the coating film. The multilayer coating film of the present invention comprising the cured first colored coating film BC1-cd2, the cured second colored coating film BC2-cd2, and the cured clear coating film CC-cd2 is thereby completed.

In the third embodiment, in addition to the matters described in the first embodiment, the clear coating composition (CC) is further specified. Specifically, in the third embodiment shown in FIG. 3, the ratio of the hydroxyl group-containing acrylic resin (A1) and the isocyanate curing agent (A2) in the clear coating composition (CC) is within a predetermined range and, further, by also determining the type of the isocyanate curing agent (A2) and the usage ratio thereof, a multilayer coating film having a particularly good cured state can be obtained.

As shown in FIG. 3(a), in the third embodiment as well, the uncured first colored coating film BC1-ncd3, the uncured second colored coating film BC2-ncd3, and the uncured clear coating film CC-ncd3 are sequentially layered. The clear coating composition (CC) constituting the uncured clear coating film CC-ncd3 includes the hydroxyl group-containing acrylic resin (A1) and the isocyanate curing agent (A2), and the isocyanate curing agent (A2) includes a diisocyanate dimer (A2-1) (also referred to as dimer (A2-1)) (indicated by ⋄) and diisocyanate trimer or higher compound (A2-2) (also referred to as (A2-2) trimer or the like) (indicated by Δ).

Diisocyanate compounds having a uretdione structure are preferred as examples of the diisocyanate dimer (A2-1) and triisocyanate compounds having an isocyanurate structure are preferred as the diisocyanate trimer or the like (A2-2).

Further, the diisocyanates for producing the dimer (A2-1) and the trimer or the like (A2-2) may be the same or different, and examples include the diisocyanates mentioned in relation to step (1). In the third embodiment, it is preferable that the molecular weight of the dimer (A2-1) is less than the molecular weight of the trimer or the like (A2-2). The isocyanate curing agent (A2) may also include polyisocyanates other than the dimer (A2-1) and the trimer or the like (A2-2) (also referred to as other polyisocyanates).

Next, when the heat treatment h in step (4), which is to say, baking, of the uncured multilayer coating film of FIG. 3(a), is started, due to the high polarity of the diisocyanate dimer (A2-1) and the trimer or the like (A2-2), some of each of the diisocyanate dimer (A2-1) and trimer or the like (A2-2) migrate from the clear coating film, for which curing has not yet been completed, to the second colored coating film BC2-ncd3 and the first colored coating film BC1-ncd3.

In the third embodiment, the clear coating composition (CC) includes the hydroxyl group-containing acrylic resin (A1) and the isocyanate curing agent (A2) in amounts such that there are 1.5 to 3.0 equivalents, and preferably 1.5 to 2.5 equivalents, of isocyanate groups in the isocyanate curing agent (A2) per 1 equivalent of hydroxyl groups in the hydroxyl group-containing acrylic resin (A1). That is to say, by causing isocyanate groups to be present in the isocyanate curing agent (A2) in excess with respect to the hydroxyl groups in the hydroxyl group-containing acrylic resin (A1), a configuration results in which the unreacted isocyanate curing agent (A2) migrates to the second colored coating film BC2-ncd3, and further to the first colored coating film BC1-ncd3. The isocyanate curing agent (A2) including the diisocyanate dimer (A2-1) and the trimer or the like (A2-2) migrates to the second colored coating film BC2-ncd3 and further to the first colored coating film BC1-ncd3 and the second colored coating film BC2-cd3 and the first colored coating film BC1-cd3, which have been cured by the reaction with the hydroxyl group-containing resin in each coating film, are formed.

By selecting the molecular weight of the dimer (A2-1) lower than the molecular weight of the trimer or the like (A2-2), the dimer (A2-1) will be able to migrate to the first colored coating film (BC1-ncd3), which is the lowest layer, so that sufficient curing of the first colored coating film BC1-ncd3 can be achieved.

Furthermore, by blending dimer (A2-2) and the trimer or the like (A2-1) at a solids-content mass ratio within the range of 10/90 to 40/60, both the second colored coating film BC2-ncd3 and the first colored coating films BC1-ncd3 can be sufficiently cured.

The multilayer coating film of the present invention comprising the cured first colored coating film BC1-cd3, the cured second colored coating film BC2-cd3, and the cured clear coating film CC-cd3 is thereby completed.

In the fourth embodiment, in addition to the matters described in the first embodiment, the clear coating composition (CC) is further specified. Specifically, the fourth embodiment shown in FIG. 4 is one in which a 3-isocyanatopropyltrialkoxysilane compound (A3) is blended into a clear coating composition (CC).

Regarding the fourth embodiment, FIG. 4(a) shows an uncured multilayer coating in which an uncured first colored coating film BC1-ncd4, an uncured second colored coating film BC2-ncd4, and an uncured clear coating film CC-ncd4 are sequentially layered. The clear coating film CC-ncd4 composed of the clear coating composition (CC) includes an isocyanate curing agent (A2) (indicated by ▴) and a 3-isocyanatopropyltrialkoxysilane compound (A3) (indicated by ▪).

Next, when the heat treatment h of the uncured multilayer coating film in FIG. 4(a) is started, due to the high polarity of the isocyanate curing agent (A2) and 3-isocyanatopropyltrialkoxysilane compound (A3), some of each of the isocyanate curing agent (A2) and the 3-isocyanatopropyltrialkoxysilane compound (A3) migrate from the clear coating film, for which curing has not yet been completed, to the second colored coating film BC2-ncd4 and the first colored coating film BC1-ncd4. Since the 3-isocyanatopropyltrialkoxysilane compound (A3) has a lower molecular weight and lower viscosity than the isocyanate curing agent (A2), it can migrate to the first colored coating film BC1-ncd4, which is the lowest layer, and the first colored coating films BC1-ncd4 can be sufficiently cured.

Furthermore, by causing the blending amount (solids content) of the 3-isocyanatopropyltrialkoxysilane compound (A3) to be 2 to 50 mass %, and preferably 2 to 20 mass %, with respect to the total mass of the solids contents of all of the resin components included in the clear coating composition (CC), both the second colored coating film BC2-ncd4 and the first colored coating film BC1-ncd4 can be sufficiently cured. The multilayer coating film of the present invention comprising the cured first colored coating film BC1-cd4, the cured second colored coating film BC2-cd4, and the cured clear coating film CC-cd4 is thereby completed.

As described above, the multilayer coating film of the present invention is used in the form of a single multilayer coating film as shown in FIGS. 1 to 4, for an exterior coating on objects to be coated such as automobile bodies.

Furthermore, if recoating of the multilayer coating film is required, a laminate of multilayer coating films can also be produced by sequentially applying, on top of the cured clear coating film CC-cd1, an uncured first colored coating film, an uncured second colored coating film, and an uncured clear coating film, and then performing heat treatment. In that case, the clear coating film CC-cd1 exhibits good recoat adhesion because the unsaturated fatty acid ester polyol (D) increases the crosslinking density.

As described above, with the method for producing a multilayer coating film of the present invention or the clear coating film composition (CC) of the present invention, even when heated at low temperatures (70 to 100° C.), it is possible to produce a multilayer coating film that can satisfy coating film performance such as recoat adhesion, gasoline resistance, chipping resistance, and water resistance, in a well-balanced manner.

The method of forming a multilayer coating film of the present invention and the multilayer coating film obtained therefrom can be applied to automobile bodies, components, and parts such as those of passenger cars, trucks, motorcycles, and buses. When the object to be coated is metal, it is particularly effective for use on automobile bodies, and when the object to be coated is plastic, it is particularly effective for use on interior and exterior parts of automobiles.

Further, the clear coating composition (CC) of the present invention is coated on an uncured second colored coating film formed from an aqueous one-part type colored coating composition (BC2) on an uncured first colored coating film formed from an aqueous first colored coating composition (BC1), so as to form an uncured clear coating film, and simultaneously heated and cured with the first colored coating film and the second colored coating film, so as to form a multilayer coating film. That is to say, the clear coating composition (CC) of the present invention is applied to the aforementioned automobile bodies, components, and parts, as part of a multilayer coating film formed by the method of the present invention.

### EXAMPLES

Hereafter, the present invention is described in greater detail by way of examples, but the present invention is not limited to these examples. Furthermore, in the examples, “parts” means “parts by mass” unless otherwise specified and, in relation to blending amounts and contents, “%” means “mass %”.

### Methods for Measuring Resin Characteristic Values

In the present invention, resin characteristic values were measured by the following method.

### 1. Resin Solids Content

The resin solids content was determined by measuring the mass of 1.0 g of the sample after heating at 130° C. for 60 minutes.

### 2. Gel Fraction

First, 1.0 g of a sample was heated at 130° C. for 60 minutes, and the mass was measured. Next, the heated sample was immersed in excess tetrahydrofuran at 25° C. for 24 hours to extract dissolved components. Thereafter, the gel fraction was determined by drying the remaining insoluble components at 50° C. for 4 hours and measuring the mass.

### 3. Hydroxyl Value

Measured in accordance with JIS-K1557.

### 4. Acid Value

Measured in accordance with JIS-K5601.

### <Production Example 1: Production of Aqueous Dispersion CS-1 of Urethane Core/Acrylic Shell Particles for Aqueous First Colored Coating Composition and Aqueous One-Part Type Second Colored Coating Composition (BC1 and BC2)>

### 1-(1) Production of Polyester Polyol Solution PE-1

54.0 parts of dimer acid PRIPOL 1017 (trade name, made by Croda Japan Co., Ltd.) having a C36 dicarboxylic acid produced by dimerization of a C18 unsaturated fatty acid as a principal component, 16.3 parts of isophthalic acid, and 29.7 parts of 1,6-hexanediol were charged into a flask fitted with a reflux condenser with a separation tube for reaction water, a thermometer, a stirrer, and a nitrogen gas inlet tube and heated to 160° C. while stirring under a nitrogen flow. After holding at 160° C. for 1 hour, the temperature was raised to 230° C. over 5 hours. The acid value was periodically measured while maintaining the temperature at 230° C., and when the acid value reached 3.5 mg KOH/g, this was cooled to 80° C. or lower. Finally, 31.0 parts of methyl ethyl ketone were added to obtain polyester polyol solution PE-1. The characteristic values of the polyester polyol solution PE-1 were an acid value of 3.5 mg KOH/g, a hydroxyl value of 73 mg KOH/g, and a resin solids content of 75 mass %.

### 1-(2) Production of Aqueous Dispersion of Allyl Group-Containing Unsaturated Polyester Urea Urethane PU-1

586.7 parts of the polyester polyol solution PE-1 obtained in Production Example 1-(1), 71.0 parts of dimethylolpropionic acid, and 278.7 parts of methyl ethyl ketone were charged into a flask equipped with a reflux condenser, a thermometer, a stirrer, and a nitrogen gas inlet tube, and the mixture was stirred to homogeneity under a nitrogen flow.

Next, 279.5 parts of isophorone diisocyanate was added to the resulting solution. After the exothermic reaction subsided, the reaction mixture was gradually heated to 80° C. while stirring, and stirring was continued at this temperature until the content of isocyanate groups in the solution was 3.3 mass %. Thereafter, 9.4 parts of allyl alcohol, 22.2 parts of trimethylolpropane, and 21.3 parts of methyl ethyl ketone were added, and the mixture was stirred at 80° C. until the content of isocyanate groups in the solution was reduced to 1.0 mass %. Next, 22.6 parts of diethanolamine were added and the content of isocyanate groups was monitored until free isocyanate groups were no longer detectable. Next, 28.8 parts of methyl ethyl ketone, 142.3 parts of methoxypropanol, and 45.5 parts of triethylamine were added to the resulting polyurethane solution. After 30 minutes from the addition of triethylamine, the temperature of the solution was lowered to 60° C. and 1977 parts of deionized water were added while stirring over a period of 30 minutes. Thereafter, a separation tube was attached to the reflux condenser, and the solvent was removed at 60° C. under reduced pressure until the resin solids content of the dispersion reached 29 mass %, to obtain an aqueous dispersion of allyl-containing unsaturated polyester urea urethane PU-1.

The resulting aqueous dispersion of allyl-containing unsaturated polyester urea urethane PU-1 had an acid value of 35 mg KOH/g, a hydroxyl value of 28 mg KOH/g, and a pH of 7.1.

### 1-(3) Production of Aqueous Dispersion of Urethane Core/Acrylic Shell Particles CS-1

1,961.2 parts of the aqueous dispersion of allyl-containing unsaturated polyester urea urethane PU-1 obtained in Production Example 1-(2), 43.3 parts of methoxypropanol, 744.4 parts of deionized water, and 3.6 parts of triethylamine were charged into a flask equipped with two dropping devices, a reflux condenser, a thermometer, a stirrer, and a nitrogen gas inlet tube, stirred under a nitrogen flow, and heated to 80° C. Thereafter, 0.6 parts of ammonium persulfate were dissolved in 35.7 parts of deionized water and added to the reaction vessel.

Subsequently, while stirring, using one dropping device, a monomer mixture consisting of 538.3 parts of n-butyl methacrylate, 26.3 parts of 2-hydroxyethyl acrylate, 4.2 parts of allyl methacrylate, and 70.0 parts of butyl glycol was added dropwise at a constant rate over 5 hours. At the same time as the dropwise addition using the aforementioned dropping device, a polymerization initiator solution consisting of 1.1 parts of ammonium persulfate and 71.3 parts of deionized water was added dropwise at a constant rate over 5 hours using the other dropping device.

After the monomer mixture solution and the polymerization initiator solution were added dropwise, the resulting reaction mixture was further stirred at 80° C. for 1 hour, and then cooled to room temperature to obtain an aqueous dispersion of urethane core/acrylic shell particles CS-1.

The resulting aqueous dispersion of urethane core/acrylic shell particles CS-1 had an acid value of 18 mg KOH/g, a hydroxyl value of 25 mg KOH/g, a resin solids content of 33 mass %, a pH of 7.1, and a gel fraction of 83 mass %.

### <Production Example 2: Production of Aqueous Dispersion of Polyurethane-Polyurea Particles UU-1 for the Aqueous First Colored Coating Composition and the Aqueous One-Part Type Second Colored Coating Composition (BC1 and BC2)>

### 2-(1) Production of Diketimine Solution DK-1 Using Diethylenetriamine and Methyl Isobutyl Ketone

180.0 parts of diethylenetriamine and 531.9 parts of methyl isobutyl ketone were charged into a flask equipped with a reflux condenser with a separation tube for reaction water, a thermometer, a stirrer, and a nitrogen gas inlet tube, this was stirred under a nitrogen flow, and the reaction water was removed at 130-150° C. When distillation of the reaction water had ended, the mixture was cooled to obtain a diketimine solution DK-1.

### 2-(2) Production of Aqueous Dispersion of Polyurethane-Polyurea Particles UU-1

746.3 parts of the polyester polyol solution PE-1 obtained in Production Example 1-(1), 27.2 parts of dimethylolpropionic acid, 3.8 parts of dibutyltin dilaurate, and 157.9 parts of methyl ethyl ketone were charged into a flask equipped with a reflux condenser, a thermometer, a stirrer, and a nitrogen gas inlet tube, and the mixture was stirred to homogeneity under a nitrogen flow.

Next, 201.8 parts of dicyclohexylmethane 4,4′-diisocyanate was added to the resulting solution. After the exothermic reaction subsided, the reaction mixture was gradually heated to 80° C. while stirring. Stirring was continued at this temperature until the content of isocyanate groups in the solution reached 1.5 mass %. Thereafter, 626.2 parts of methyl ethyl ketone was added and the reaction mixture was cooled to 40° C. After cooling, 11.8 parts of triethylamine was added over 2 minutes and stirred for 5 minutes. Next, 30.2 parts of the diketimine solution DK-1 obtained in Production Example 2-(1) was added over 1 minute, and this was stirred at 40° C. for 30 minutes. Additionally, 1206 parts of deionized water were added over 7 minutes while stirring. Thereafter, a separation tube was attached to the reflux condenser, and the solvent was removed at 45° C. under reduced pressure until the resin solids content of the dispersion reached 40 mass %, to obtain an aqueous dispersion of polyurethane-polyurea particles UU-1.

The resulting aqueous dispersion of polyurethane-polyurea particles UU-1 had an acid value of 17 mg KOH/g, a pH of 7.4, and a gel fraction of 87 mass %.

### Production Example 3: Production of an Aqueous Acrylic Urethane Dispersion AU-1 for the Aqueous First Colored Coating Composition (BC1)

### 3-(1) Production of Polyester Polyol Solution PE-2

49.9 parts of adipic acid, 18.5 parts of 1,6-hexanediol, and 31.6 parts of neopentyl glycol were charged into a flask equipped with a reflux condenser with a separation tube for reaction water, a thermometer, a stirrer, and a nitrogen gas inlet tube, and the temperature was raised to 160° C. while stirring under a nitrogen flow. After holding at 160° C. for 1 hour, the temperature was raised to 230° C. over 5 hours. The acid value was periodically measured while maintaining the temperature at 230° C., and when the acid value reached 3.5 mg KOH/g, this was cooled to 80° C. or lower. Lastly, 21.9 parts of methyl ethyl ketone was added to obtain a polyester polyol solution PE-2. The characteristic values of the polyester polyol solution PE-2 were an acid value of 3.5 mg KOH/g, a hydroxyl value of 155 mg KOH/g, and a resin solids content of 80 mass %.

### 3-(2) Production of Aqueous Acrylic Urethane Dispersion AU-1

420.0 parts of the polyester polyol solution PE-2 obtained in Production Example 3-(1), 31.0 parts of neopentyl glycol, 27.8 parts of trimethylolpropane monoallyl ether, 0.5 parts of dibutyltin dilaurate, and 195.7 parts of methyl ethyl ketone were charged into a flask equipped with two dropping devices, a reflux condenser, a thermometer, a stirrer, and a nitrogen gas inlet tube, and stirred to homogeneity under a nitrogen flow.

Next, 259.9 parts of isophorone diisocyanate was added to the resulting solution. After the exothermic reaction had subsided, the reaction mixture was gradually heated to 80° C. while stirring, and stirring was continued at this temperature until the isocyanate content of the solution reached 2.2 mass %. 66.7 parts of trimethylolpropane were then added and stirred at 80° C. until free isocyanate groups were no longer detectable in the solution. Thereafter, 248.9 parts of methyl ethyl ketone was added to the resulting polyurethane solution.

Subsequently, the temperature was adjusted to 82° C. and, using one dropping device, a monomer mixture comprising 312.5 parts of n-butyl acrylate, 312.5 parts of methyl methacrylate, 74.7 parts of 2-hydroxypropyl methacrylate, and 58.4 parts of acrylic acid were added dropwise at a constant rate over 3 hours. At the same time as the dropwise addition using the aforementioned dropping device, a polymerization initiator solution comprising 22.8 parts of 2,2′-azobis(methylbutyronitrile) and 152.3 parts of methyl ethyl ketone was added dropwise at a constant rate over 3.5 hours using the other dropping device.

After the monomer mixture and polymerization initiator solution were added dropwise, the resulting reaction mixture was further stirred at 82° C. for 2.5 hours, and 56.9 parts of dimethylethanolamine and 2242 parts of deionized water were added. Thereafter, a separation tube was attached to the reflux condenser, and the solvent was removed at 45° C. under reduced pressure until the resin solids content of the dispersion reached 40 mass % to obtain an aqueous acrylic urethane dispersion AU-1.

The resulting aqueous acrylic urethane dispersion AU-1 had an acid value of 32 mg KOH/g, a hydroxyl value of 57 mg KOH/g, and a pH of 8.1.

### Production Example 4: Production of an Aqueous Dispersion of Polyester Polyol PE-3 for the Aqueous One-Part Type Second Colored Coating Composition (BC2)

171.0 parts of dimer acid PRIPOL 1017 (trade name, made by Croda Japan Co., Ltd.) having a C36 carbon dicarboxylic produced by dimerization of a C18 unsaturated fatty acid as a principal component, 72.9 parts of neopentyl glycol, 82.7 parts of 1,6-hexanediol, and 46.2 parts of hexahydrophthalic anhydride were charged into a flask fitted with a reflux condenser with a separation tube for reaction water, a thermometer, a stirrer, and a nitrogen gas inlet tube, and heated to 160° C. while stirring under a nitrogen flow. After holding at 160° C. for 1 hour, the temperature was raised to 230° C. over 5 hours. The acid value was periodically measured while maintaining the temperature at 230° C. and, when the acid value reached 8.5 mg KOH/g, this was cooled to 140° C. Next, 76.8 parts of trimellitic anhydride was added, and the reaction was continued at 180° C. until the acid value reached 30 mg KOH/g. Thereafter, this was cooled to 120° C., 140.2 parts of butanol were added and, after further cooling to 90° C., 1.6 parts of dimethylethanolamine and 140.2 parts of deionized water were added, whereby an aqueous dispersion of polyester polyol PE-3 was obtained.

The resulting aqueous dispersion of polyester polyol PE-3 had an acid value of 30 mg KOH/g, a hydroxyl value of 83 mg KOH/g, a resin solids content of 60 mass %, and a pH of 7.8.

### Production Example 5: Production of Aqueous First Colored Coating Compositions BC1-1 and BC1-2

### 5-(1) Production of Black Paste PP-1

25.0 parts of the aqueous acrylic urethane dispersion AU-1 obtained in Production Example 3, 10.0 parts of carbon black pigment MA100 (trade name, made by Mitsubishi Chemical Corporation), 0.1 parts of methyl isobutyl ketone, 1.4 parts of dimethyl ethanolamine, 2.0 parts of the polyalkylene glycol, Pluriol P900 (trade name, made by BASF), and 61.5 parts of deionized water were mixed and dispersed with a motor mill, whereby a black paste PP-1 was obtained.

### 5-(2) Production of White Paste PP-2

43.0 parts of the aqueous acrylic urethane dispersion AU-1 obtained in Production Example 3, 50.0 parts of titanium dioxide pigment Ti-Pure R706 (trade name, made by Chemours Company), 0.3 parts of 1-propoxy-2-propanol, and 6.7 parts of deionized water were mixed and dispersed with a motor mill, whereby a white paste PP-2 was obtained.

### 5-(3) Production of Aqueous First Colored Coating Compositions BC1-1 and BC1-2

The components listed in Table 1 were mixed in the order listed and stirred for an additional 30 minutes. Next, dimethylethanolamine was added to adjust the pH to 8.5. Thereafter, deionized water was added to adjust the viscosity to 100 mPa·s, as measured at 23° C. and a shear rate of 1000 s⁻¹ using the rotational viscometer, Rheomat RM180 (trade name, made by METTLER TOLEDO).

TABLE 1

| 1 | [symbol] | BC1-1 | BC1-2 |
|---|---|---|---|
| 2 | [symbol] | 30. 0 | 30. 0 |
| | CS-1 | | |
| 3 | [symbol] | 25. 4 | 25. 4 |
| | 1 | | |
| 4 | [symbol] | 2. 0 | 2. 0 |
| 5 | [symbol] | 38. 0 | 38. 0 |
| 6 | [symbol] | 1. 0 | 1. 0 |
| 7 | [symbol] | 0. 5 | 0. 5 |
| 8 | [symbol] | 0. 2 | 0. 2 |
| 9 | [symbol] | 4. 4 | |
| 10 | [symbol] | | 10. 0 |

| Number | Source | Translation |
|---|---|---|
| 1 | [symbol] | Aqueous first colored |
| | | coating composition |
| 2 | [symbol] | aqueous dispersion of |
| | [symbol] | urethane core/acrylic |
| | | shell particles CS-1 |
| 3 | [symbol] | aqueous dispersion of |
| | [symbol] | polyurethane- |
| | | polyurea particles UU-1 |
| 4 | [symbol] | butyl glycol |
| 5 | [symbol] | white paste PP-2 |
| 6 | [symbol] | black paste PP-1 |
| 7 | [symbol] | surface conditioner¹⁾ |
| 8 | [symbol] | acrylic thickener²⁾ |
| 9 | [symbol] | melamine resin solution³⁾ |
| 10 | [symbol] | aqueous solution of |
| | | carbodiimide curing agent⁴⁾ |

1) Surfynol 104PA (trade name, made by Nissin Chemical Industry Co., Ltd., active component 50 mass)
2) Rheovis HS 1162 (trade name, made by BASF)
3) CYMEL 327 (trade name, made by Allnex, resin solids content 90 mass)
4) CARBODILITE V-02-L2 (trade name, made by Nisshinbo Chemical Inc., resin solids content 40 mass)

### Production Example 6: Production of Aqueous One-Part Type Second Colored Coating Composition BC2-1

The components listed in the Aqueous Phase section of Table 2 were mixed in the order listed and stirred for an additional 60 minutes to obtain an aqueous mixture. Next, in a separate container, the components listed in the Organic Phase section were mixed in the order listed to obtain an organic mixture. The resulting organic mixture was then added to the aqueous mixture and stirred for an additional 30 minutes. Subsequently, dimethylethanolamine was added to adjust the pH to 8.0. Thereafter, deionized water was added to adjust the viscosity to 100 mPa·s, as measured at 23° C. and a shear rate of 1000 s⁻¹ using the rotational viscometer, Rheomat RM180 (trade name, made by METTLER TOLEDO).

TABLE 2

| 1 | [symbol] | | | BC2-1 |
|---|---|---|---|---|
| 2 | [symbol] | 4 | [symbol] | 30. 0 |
| | | | S-1 | |
| | | 5 | [symbol] | 12. 2 |
| | | 6 | [symbol] | 1. 0 |
| | | 7 | [symbol] | 1. 0 |
| | | 8 | [symbol] | 10. 0 |
| | | 9 | [symbol] | 7. 0 |
| | | 10 | [symbol] | 0. 3 |
| | | 11 | [symbol] | 4. 8 |
| 3 | [symbol] | 12 | [symbol] | 6. 0 |
| | | 13 | [symbol] | 6. 5 |
| | | 14 | [symbol] | 4. 0 |

| Number | Source | Translation |
|---|---|---|
| 1 | [symbol] | Aqueous one-part |
| | [symbol] | type second |
| | | colored coating |
| | | composition |
| 2 | [symbol] | Aqueous phase |
| 3 | [symbol] | Organic phase |
| 4 | [symbol] | aqueous |
| | [symbol] | dispersion of |
| | | urethane |
| | | core/acrylic |
| | | shell particles |
| | | CS-1 |
| 5 | [symbol] | aqueous |
| | [symbol] | dispersion of |
| | | polyurethane- |
| | | polyurea |
| | | particles UU-1 |
| 6 | [symbol] | 2-ethylhexanol |
| 7 | [symbol] | surface |
| | | conditioner¹⁾ |
| 8 | [symbol] | deionized water |
| 9 | [symbol] | inorganic |
| | | thickener⁵⁾ |
| 10 | [symbol] | alkaline |
| | | swellable |
| | | emulsion⁶⁾ |
| 11 | [symbol] | melamine resin |
| | | solution³⁾ |
| 12 | [symbol] | aluminum paste⁷⁾ |
| 13 | [symbol] | butyl glycol |
| 14 | [symbol] | aqueous |
| | [symbol] | dispersion of |
| | | polyester polyol |
| | | PE-3 |

5) Mixture of 3 parts by mass of Laponite RD (trade name, made by BYK), 3 parts by mass of Pluriol P900 (trade name, made by BASF), and 94 parts by mass of deionized water
6) Rheovis AS 1130 (trade name, made by BASF)
7) STAPA IL HYDROLAN 2192 55900/G (trade name, made by ECKART, pigment content 60 mass)

### Production Example 7: Production of Solutions of Hydroxyl Group-Containing Acrylic Resins A1-1 to A1-10 for Clear Coating Compositions (CC)

7-(1) Production of Hydroxyl Group-Containing acrylic Resin A1-1 Solution

99.0 parts of ethyl 3-ethoxypropionate, serving as a solvent, was charged into a flask equipped with a dropping device, a reflux condenser, a thermometer, a stirrer, and a nitrogen gas inlet tube, and heated to 75° C. while stirring under a nitrogen flow. A mixture of 10.0 parts of styrene, 25.0 parts of 4-hydroxybutyl acrylate, 10.0 parts of 2-hydroxyethyl methacrylate, 55.0 parts of isobutyl methacrylate, serving as monomers, and 1.0 part of 2,2′-azobis(isobutyronitrile) serving as a polymerization initiator, in a dropping device, was added dropwise at a constant rate over 3 hours while maintaining the temperature at 75° C., and then stirring was continued at 75° C. for an additional 5 hours. After confirming that the conversion ratio exceeded 98% by measuring the resin solids content, this was cooled to obtain a hydroxyl group-containing acrylic resin A1-1 solution.

### 7-(2) Production of Hydroxyl Group-Containing Acrylic Resin A1-2 to A1-10 Solutions

Hydroxyl group-containing acrylic resin A1-2 to A1-10 solutions were prepared in the same manner as the hydroxyl group-containing acrylic resin (A1-1) solution, except that the initial solvent amount, monomer composition, blending amount, and initiator amount were changed as set forth in Table 3. Table 3 also lists the solubility parameters (HSP) in Hansen space of the hydroxyl group-containing acrylic resins A1-1 to A1-10.

TABLE 3

| | | | | | | | [symbol] | | |
|---|---|---|---|---|---|---|---|---|---|
| | | | | | [symbol] | [symbol] | [symbol] | | |
| [symbol] | | | | | (OHV) | [symbol] | (HSP) (cal/cm³)^{1/2} | | |
| [symbol] | [symbol] | [symbol] | [symbol] | [symbol] | mgKOH/g | (Mw) | δD₁ | δP₁ | δH₁ |
| A1-1 | 99.0 | ST/4HBA/HEMA/IBMA | 10/25/10/55 | 1.0 | 141 | 8000 | 8.74 | 2.30 | 5.17 |
| A1-2 | 99.0 | ST/HEMA/HPMA/CHMA/IBMA/EHA | 10/10/10/20/9/41 | 1.0 | 86 | 8000 | 8.70 | 1.85 | 4.31 |
| A1-3 | 97.0 | ST/HEMA/HPMA/MMA/IBMA/EHA | 8/18/25/5/41/2 | 3.0 | 181 | 6000 | 8.79 | 2.53 | 5.69 |
| A1-4 | 95.5 | ST/4HBA/HEMA/CHMA/IBMA/MMA | 10/25/10/5/40/10 | 4.5 | 141 | 5000 | 8.82 | 2.41 | 5.26 |
| A1-5 | 92.5 | ST/4HBA/HEMA/BMA | 10/25/10/55 | 7.5 | 141 | 4000 | 8.74 | 2.30 | 5.17 |
| A1-6 | 98.2 | ST/4HBA/HEMA/MMA/CHMA/IBMA | 10/30/10/5/5/40 | 1.8 | 160 | 7000 | 8.84 | 2.42 | 5.42 |
| A1-7 | 99.8 | ST/4HBA/HEMA/IBMA | 10/25/10/55 | 0.2 | 141 | 30000 | 8.74 | 2.30 | 5.17 |
| A1-8 | 88.5 | ST/HEMA/HPMA/MMA/IBMA/EHA | 8/18/25/5/41/2 | 11.5 | 181 | 3000 | 8.79 | 2.53 | 5.69 |
| A1-9 | 92.5 | ST/HPMA/EHA | 40/10/50 | 7.5 | 43 | 4000 | 8.96 | 1.51 | 3.21 |
| A1-10 | 98.2 | ST/HPMA/IBMA/EHA | 40/5/20/35 | 1.8 | 22 | 7000 | 8.93 | 1.51 | 2.98 |

| Number | Source | Translation |
|---|---|---|
| 1 | [symbol] | Hydroxyl group- |
| | (A1) | containing |
| | | acrylic resin (A1) |
| 2 | [symbol] | Parts by mass of |
| | | initial solvent |
| 3 | [symbol] | Monomer |
| | | composition |
| 4 | [symbol] | Parts by mass of |
| | | monomers |
| 5 | [symbol] | Parts by mass of |
| | | initiator |
| 6 | [symbol] | Hydroxyl value |
| | | (OHV) mg KOH/g |
| 7 | [symbol] | Mass average |
| | | molecular weight |
| | | (Mw) |
| 8 | [symbol] | Solubility |
| | [symbol] | parameters (HSP) |
| | (cal/cm³)^{1/2} | in Hansen space |
| | | (cal/cm³)^{1/2} |

The abbreviations in Table 3 are indicated below.
ST: Styrene
4HBA: 4-hydroxybutyl acrylate
HEMA: 2-hydroxyethyl methacrylate
IBMA: isobutyl methacrylate
HPMA: 2-hydroxypropyl methacrylate
MMA: methyl methacrylate
EHA: 2-ethylhexyl acrylate
CHMA: cyclohexyl methacrylate

### Production Example 8: Production of Clear Coating Compositions CC1 to CC52

### 8-(1) Unsaturated Fatty Acid Ester Polyols D-1 to D-5

The structure of the unsaturated fatty acid ester polyol D-1 (glyceryl trilinolenate) used is shown below.

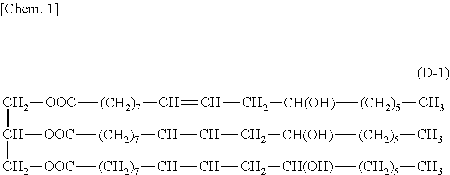

The structure of the unsaturated fatty acid ester polyol D-2 (glyceryl diricinoleate) used is shown below.

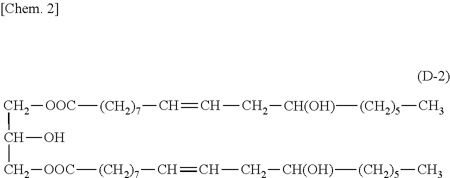

The structure of the unsaturated fatty acid ester polyol D-3 (glyceryl monoricinoleate) used is shown below.

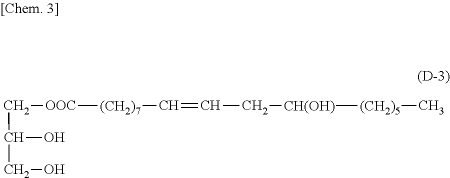

The structure of the unsaturated fatty acid ester polyol D-4 (diglyceryl monoricinoleate) used is shown below.

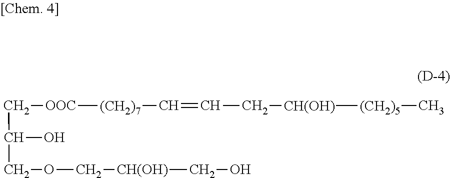

The structure of the unsaturated fatty acid ester polyol D-5 (dipentaerythritol monoricinoleate) used is shown below.

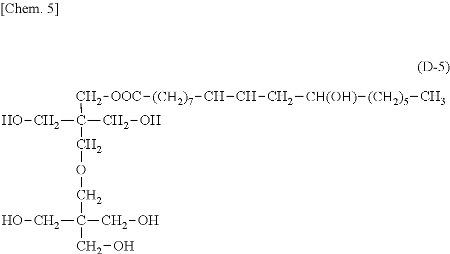

Further, the solubility parameters (HSP) in Hansen space of the unsaturated fatty acid ester polyols D-1 to D-5 are shown together in Table 4.

TABLE 4

| | [symbol] | | | |
|---|---|---|---|---|
| [symbol] | [symbol] | | | |
| [symbol] | (HSP) (cal/cm³)^{1/2} | | | |
| [symbol] | δD₂ | δP₂ | δH₂ | δT(D) |
| D-1 | 8.30 | 0.64 | 4.58 | 9.50 |
| D 2 | 8.35 | 0.85 | 5.28 | 9.92 |
| D-3 | 8.50 | 1.40 | 6.78 | 10.96 |
| D-4 | 8.68 | 1.47 | 7.40 | 11.50 |
| D-5 | 9.07 | 1.53 | 8.39 | 12.45 |

| Number | Source | Translation |
|---|---|---|
| 1 | [symbol] | Unsaturated fatty |
| | [symbol] | acid ester polyol |
| | | (D) |
| 2 | [symbol] | Solubility |
| | [symbol] | parameters (HSP) |
| | (cal/cm³)^{1/2} | in Hansen space |
| | | (cal/cm³)^{1/2} |

### 8-(2) Production of Clear Coating Composition CC1

84.6 parts of hydroxyl group-containing acrylic resin A1-1 solution, 3 parts of unsaturated fatty acid ester polyol D-1, 22.4 parts of isocyanate curing agent A2-1 (1.0 equivalents of isocyanate groups in the isocyanate curing agent A2-1, with respect to 1 equivalent of hydroxyl groups in the hydroxyl group-containing acrylic resin A1-1), and 0.01 parts of the urethane curing catalyst E-1 were weighed out and then, using ethyl 3-ethoxypropionate as a solvent, this was diluted to a Ford #4 cup viscosity of 25 seconds (20° C.) and agitated to full homogeneity with a paint shaker. Thereafter, filtration was performed using a membrane filter with openings of 200 μm to remove coarse particles and obtain a clear coating composition CC1.

### 8-(3) Production of Clear Coating Compositions CC2 to CC52

Clear coating compositions CC2 to CC52 were obtained in the same manner as the clear coating composition CC1, with changes so as to result in the blending ratios shown in Table 5. Note that, in Table 5, the amount of the hydroxyl group-containing acrylic resin (A1-1 to A1-10) solutions used was 84.6 parts in all cases.

In addition, the distance Ra between the solubility parameters of the hydroxyl group-containing acrylic resin (A1) in Hansen space and the solubility parameters of the unsaturated fatty acid ester polyol (D) in Hansen space was determined for each composition in each example and comparative example. That is to say, the values obtained by substituting the values of δD₁, δP₁, δH₁, δD₂, δP₂, and δH₂ listed in Tables 3 and 4 into the following formula (1) were set forth as Ra in Table 5.

$${R}_{a} = {[ 4 {( δ {D}_{2} - δ {D}_{1} )}^{2} + {( δ {P}_{2} - δ {P}_{1} )}^{2} + {( δ {H}_{2} - δ {H}_{1} )}^{2} ]}^{1 / 2} \qquad ( 1 )$$

TABLE 5

| | | | | 4 | | | 7 | | 8 | | 10 | |
|---|---|---|---|---|---|---|---|---|---|---|---|---|
| | | | 3 | [symbol] | | | [symbol] | | [symbol] | | [symbol] | |
| | | 2 | [symbol] | [symbol] | | | [symbol] | | [symbol] | | [symbol] | |
| | 1 | [symbol] | [symbol] | 5 | | 6 | 5 | | [symbol] | | 5 | 6 |
| | [symbol] | [symbol] | (A1) | [symbol] | Ra | [symbol] | [symbol] | NCO/OH | [symbol] | [symbol] | [symbol] | [symbol] |
| 11 | [symbol] 1 | CC1 | A1-1 | D-1 | 2.0 | 3 | A2-a | 1.0 | — | — | E-1 | 0.10 |
| 12 | [symbol] 2 | CC2 | A1-2 | D-1 | 1.5 | 5 | A2-a | 1.0 | — | — | E-1 | 0.05 |
| 13 | [symbol] 3 | CC3 | A1-3 | D-1 | 2.4 | 1 | A2-a | 1.0 | — | — | E-1 | 0.10 |
| 14 | [symbol] 4 | CC4 | A1-4 | D-1 | 2.2 | 10 | A2-b | 1.0 | — | — | E-1 | 0.05 |
| 15 | [symbol] 5 | CC5 | A1-5 | D-1 | 2.0 | 15 | A2-b | 1.0 | — | — | — | — |
| 16 | [symbol] 6 | CC6 | A1-6 | D-1 | 2.2 | 3 | A2-c | 1.7 | — | — | E-2 | 0.10 |
| 17 | [symbol] 7 | CC7 | A1-7 | D-1 | 2.0 | 5 | A2-c | 1.5 | — | — | E-2 | 0.00 |
| 18 | [symbol] 8 | CC8 | A1-8 | D-1 | 2.4 | 1 | A2-c | 1.5 | — | — | E-2 | 0.10 |
| 19 | [symbol] 9 | CC9 | A1-9 | D-1 | 2.1 | 10 | A2-d | 1.5 | — | — | E-2 | 0.05 |
| 20 | [symbol] 10 | CC10 | A1-10 | D-1 | 2.2 | 15 | A2-d | 1.7 | — | — | E-2 | 0.05 |
| 21 | [symbol] 11 | CC11 | A1-1 | D-2 | 1.6 | 5 | A2-a | 1.0 | A3-1 | 10 | E-3 | 0.10 |
| 22 | [symbol] 12 | CC12 | A1-2 | D-2 | 1.5 | 5 | A2-b | 1.0 | A3-2 | 10 | E-3 | 0.10 |
| 23 | [symbol] 13 | CC13 | A1-3 | D-2 | 1.9 | 5 | A2-b | 1.0 | A3-2 | 1 | E-3 | 0.10 |
| 24 | [symbol] 14 | CC14 | A1-4 | D-2 | 1.8 | 5 | A2-b | 0.9 | — | — | E-3 | 0.10 |
| 25 | [symbol] 15 | CC15 | A1-5 | D-2 | 1.6 | 5 | A2-d | 1.9 | — | — | E-3 | 0.10 |
| 26 | [symbol] 16 | CC16 | A1-6 | D-2 | 1.9 | 5 | A2-a | 1.0 | A3-1 | 10 | E-3 | 0.10 |
| 27 | [symbol] 17 | CC17 | A1-7 | D-2 | 1.6 | 5 | A2-a | 1.0 | A3-1 | 8 | E-3 | 0.10 |
| 28 | [symbol] 18 | CC18 | A1-8 | D-2 | 1.9 | 5 | A2-a | 1.0 | A3-1 | 8 | E-3 | 0.10 |
| 29 | [symbol] 19 | CC19 | A1-1 | D-3 | 1.9 | 5 | A2-a | 0.8 | — | — | E-3 | 0.10 |
| 30 | [symbol] 20 | CC20 | A1-2 | D-3 | 2.5 | 5 | A2-b | 1.0 | — | — | E-3 | 0.10 |
| 31 | [symbol] 21 | CC21 | A1-3 | D-3 | 1.7 | 5 | A2-b | 1.0 | — | — | E-3 | 0.10 |
| 32 | [symbol] 22 | CC22 | A1-4 | D-3 | 1.9 | 5 | A2-c | 1.5 | — | — | E-1 | 0.10 |
| 33 | [symbol] 23 | CC23 | A1-5 | D-3 | 1.9 | 5 | A2-d | 1.5 | — | — | E-1 | 0.10 |
| 34 | [symbol] 24 | CC24 | A1-6 | D-3 | 1.6 | 5 | A2-e | 2.0 | — | — | E-1 | 0.10 |
| 35 | [symbol] 25 | CC25 | A1-7 | D-3 | 1.9 | 5 | A2-d | 1.5 | — | — | E-1 | 0.10 |
| 36 | [symbol] 26 | CC26 | A1-8 | D-3 | 1.7 | 5 | A2-d | 1.5 | — | — | E-2 | 0.05 |
| 37 | [symbol] 27 | CC27 | A1-3 | D-4 | 2.0 | 5 | A2-d | 1.9 | — | — | E-2 | 0.05 |
| 38 | [symbol] 28 | CC28 | A1-4 | D-4 | 2.4 | 5 | A2-d | 3.0 | — | — | E-2 | 0.05 |
| 39 | [symbol] 29 | CC29 | A1-6 | D-4 | 2.2 | 5 | A2-b | 1.0 | A3-1 | 10 | E-2 | 0.05 |
| 40 | [symbol] 30 | CC30 | A1-8 | D-4 | 2.0 | 5 | A2-e | 1.3 | — | — | E-2 | 0.05 |
| 41 | [symbol] 31 | CC31 | A1-3 | D-5 | 2.9 | 5 | A2-d | 1.6 | — | — | E-2 | 0.05 |
| 42 | [symbol] 32 | CC32 | A1-4 | D-5 | 3.3 | 5 | A2-b | 0.9 | — | — | E-1 | 0.05 |
| 43 | [symbol] 33 | CC33 | A1-5 | D-5 | 3.4 | 5 | A2-b | 0.9 | — | — | E-1 | 0.05 |
| 44 | [symbol] 34 | CC34 | A1-6 | D-5 | 3.1 | 5 | A2-e | 1.7 | — | — | E-1 | 0.05 |
| 45 | [symbol] 35 | CC35 | A1-7 | D-5 | 3.4 | 5 | A2-e | 1.5 | — | — | E-1 | 0.05 |
| 46 | [symbol] 36 | CC36 | A1-8 | D-5 | 2.9 | 5 | A2-e | 1.6 | — | — | E-1 | 0.05 |
| 47 | [symbol] 37 | CC37 | A1-9 | D-2 | 2.5 | 5 | A2-a | 1.0 | — | — | E-1 | 0.10 |
| 48 | [symbol] 38 | CC38 | A1-10 | D-2 | 2.7 | 5 | A2-b | 1.0 | — | — | E-1 | 0.05 |
| 49 | [symbol] 39 | CC39 | A1-9 | D-3 | 3.7 | 5 | A2-c | 1.5 | — | — | E-1 | 0.10 |
| 50 | [symbol] 40 | CC40 | A1-10 | D-3 | 3.9 | 5 | A2-d | 1.5 | — | — | E-1 | 0.05 |
| 51 | [symbol] 41 | CC41 | A1-1 | D-4 | 2.4 | 5 | A2-a | 1.0 | — | — | E-1 | 0.10 |
| 52 | [symbol] 42 | CC42 | A1-2 | D-4 | 3.1 | 5 | A2-a | 1.0 | A3-1 | 3 | E-1 | 0.05 |
| 53 | [symbol] 43 | CC43 | A1-5 | D-4 | 2.4 | 5 | A2-b | 1.0 | — | — | E-1 | 0.10 |
| 54 | [symbol] 44 | CC44 | A1-7 | D-4 | 2.4 | 5 | A2-b | 1.0 | — | — | E-1 | 0.05 |
| 55 | [symbol] 45 | CC45 | A1-1 | D-5 | 3.4 | 5 | A2-c | 1.8 | — | — | E-1 | 0.10 |
| 56 | [symbol] 1 | CC46 | A1-2 | D-5 | 4.2 | 5 | A2-d | 1.6 | — | — | E-1 | 0.05 |
| 57 | [symbol] 2 | CC47 | A1-9 | D-4 | 4.2 | 5 | A2-a | 0.9 | — | — | — | — |
| 58 | [symbol] 3 | CC48 | A1-10 | D-4 | 4.4 | 5 | A2-c | 2.0 | — | — | E-3 | 0.15 |
| 59 | [symbol] 4 | CC49 | A1-9 | D-5 | 5.2 | 5 | A2-a | 1.5 | — | — | — | — |
| 60 | [symbol] 5 | CC50 | A1-10 | D-5 | 5.4 | 5 | A2-a | 0.5 | A3-1 | 10 | — | — |
| 61 | [symbol] 6 | CC51 | A1-1 | — | — | — | A2-a | 0.5 | — | — | — | — |
| 62 | [symbol] 7 | CC52 | A1-10 | — | — | — | A2-c | 1.0 | — | — | E-3 | 0.05 |

| Number | Source | Translation |
|---|---|---|
| 1 | [symbol] | Example |
| 2 | [symbol] | Clear coating composition (CC) |
| | (CC) | |
| 3 | [symbol] | Hydroxyl group-containing |
| | [symbol] | acrylic resin (A1) |
| 4 | [symbol] | Unsaturated fatty acid ester |
| | [symbol] | polyol (D) |
| | (D) | |
| 5 | [symbol] | type |
| 6 | [symbol] | parts by mass |
| 7 | [symbol] | Isocyanate curing agent (A2) |
| | [symbol] | |
| 8 | [symbol] | 3- |
| | [symbol] | Isocyanatopropyltrialkoxysilane |
| | [symbol] | compound (A3) |
| | (A3) | |
| 9 | [symbol] | type |
| 10 | [symbol] | Urethane curing catalyst (E) |
| | (E) | |
| 11 | [symbol] 1 | Example 1 |
| 12 | [symbol] 2 | Example 2 |
| 13 | [symbol] 3 | Example 3 |
| 14 | [symbol] 4 | Example 4 |
| 15 | [symbol] 5 | Example 5 |
| 16 | [symbol] 6 | Example 6 |
| 17 | [symbol] 7 | Example 7 |
| 18 | [symbol] 8 | Example 8 |
| 19 | [symbol] 9 | Example 9 |
| 20 | [symbol] 10 | Example 10 |
| 21 | [symbol] 11 | Example 11 |
| 22 | [symbol] 12 | Example 12 |
| 23 | [symbol] 13 | Example 13 |
| 24 | [symbol] 14 | Example 14 |
| 25 | [symbol] 15 | Example 15 |
| 26 | [symbol] 16 | Example 16 |
| 27 | [symbol] 17 | Example 17 |
| 28 | [symbol] 18 | Example 18 |
| 29 | [symbol] 19 | Example 19 |
| 30 | [symbol] 20 | Example 20 |
| 31 | [symbol] 21 | Example 21 |
| 32 | [symbol] 22 | Example 22 |
| 33 | [symbol] 23 | Example 23 |
| 34 | [symbol] 24 | Example 24 |
| 35 | [symbol] 25 | Example 25 |
| 36 | [symbol] 26 | Example 26 |
| 37 | [symbol] 27 | Example 27 |
| 38 | [symbol] 28 | Example 28 |
| 39 | [symbol] 29 | Example 29 |
| 40 | [symbol] 30 | Example 30 |
| 41 | [symbol] 31 | Example 31 |
| 42 | [symbol] 32 | Example 32 |
| 43 | [symbol] 33 | Example 33 |
| 44 | [symbol] 34 | Example 34 |
| 45 | [symbol] 35 | Example 35 |
| 46 | [symbol] 36 | Example 36 |
| 47 | [symbol] 37 | Example 37 |
| 48 | [symbol] 38 | Example 38 |
| 49 | [symbol] 39 | Example 39 |
| 50 | [symbol] 40 | Example 40 |
| 51 | [symbol] 41 | Example 41 |
| 52 | [symbol] 42 | Example 42 |
| 53 | [symbol] 43 | Example 43 |
| 54 | [symbol] 44 | Example 44 |
| 55 | [symbol] 45 | Example 45 |
| 56 | [symbol] 1 | Comparative Example 1 |
| 57 | [symbol] 2 | Comparative Example 2 |
| 58 | [symbol] 3 | Comparative Example 3 |
| 59 | [symbol] 4 | Comparative Example 4 |
| 60 | [symbol] 5 | Comparative Example 5 |
| 61 | [symbol] 6 | Comparative Example 6 |
| 62 | [symbol] 7 | Comparative Example 7 |

The abbreviations in Table 5 are as indicated below.
Isocyanate curing agent A2-a: DUPANATE TPA-100 (trade name, made by Asahi Kasei Corporation, diisocyanate trimer or higher compound)
Isocyanate curing agent A2-b: DURANATE TKA-100 (trade name, made by Asahi Kasei Corporation, diisocyanate trimer or higher compound) Isocyanate curing agent A2-c: DURANATE TUL-100 (trade name, made by Asahi Kasei Corporation, diisocyanate dimer content 14%)
Isocyanate curing agent A2-d: DURANATE TLA-100 (trade name, made by Asahi Kasei Corporation, diisocyanate dimer content 12%)
Isocyanate curing agent A2-e: DESMODUR N3400 (trade name, made by Covestro, diisocyanate dimer content 38%)
3-Isocyanatopropyltrialkoxysilane compound A3-1: KBE-9007N (trade name, made by Shin-Etsu Chemical Co., Ltd., (3-isocyanatopropyl)triethoxysilane)
3-Isocyanatopropyltrialkoxysilane compound A3-2: (3-isocyanatopropyl)trimethoxysilane)
Urethane curing catalyst E-1: K-KAT XK-614 (trade name, made by Kusumoto Chemicals, Ltd.)
Urethane curing catalyst E-2: K-KAT 670 (trade name, made by Kusumoto Chemicals, Ltd.)
Urethane curing catalyst E-3: dibutyltin dilaurate

### Examples 1 to 45 and Comparative Examples 1 to 7

### Preparation of Test Plates

A cationic electrodeposition coating, CathoGuard No. 500 (trade name, made by BASF Coatings), was applied by electrodeposition to a film thickness of 20 μm on cold-rolled steel plates (150 mm×75 mm×0.8 mm) that had been treated with zinc phosphate, and this was cured by heating at 170° C. for 30 minutes.

The test plates were electrostatically coated with the aqueous first colored coating compositions (BC1) shown in Table 6 so as to produce the dry film thicknesses shown in Table 6, and left at room temperature for 10 minutes, then the second aqueous one-part type colored coating composition BC2-1 was electrostatically coated so as to produce a dry film thickness of 10 μm, and left at room temperature for 5 minutes, whereafter preliminary drying (flash-off) was performed at 80° C. for 5 minutes. Next, the clear coating compositions (CC) listed in Table 6 were electrostatically coated so as to result in dry film thicknesses of 35 μm, these were left at room temperature for 10 minutes, and then heated at 85° C. for 20 minutes to obtain test coated plates on which a multilayer coating had been formed.

TABLE 6

| | | | | [symbol] | | | | | | |
|---|---|---|---|---|---|---|---|---|---|---|
| | | | 3 | [symbol] | | | | 9 | | |
| | | | [symbol] | (BC1) | | | | [symbol] | | 12 |
| | 1 | 2 | [symbol] | | [symbol] | 7 | 8 | 10 | 11 | [symbol] |
| | [symbol] | [symbol] | (CC) | [symbol] | (μm) | [symbol] | [symbol] | [symbol] | [symbol] | [symbol] |
| 13 | [symbol] 1 | 65 [symbol] 1 | CC1 | BC-1 | 20 | 117 ⊚ | 118 ◯ | 117 ⊚ | 117 ⊚ | 117 ⊚ |
| 14 | [symbol] 2 | 66 [symbol] 2 | CC2 | BC-1 | 30 | 118 ◯ | 118 ◯ | 117 ⊚ | 117 ⊚ | 117 ⊚ |
| 15 | [symbol] 3 | 67 [symbol] 3 | CC3 | BC-1 | 30 | 118 ◯ | 118 ◯ | 117 ⊚ | 117 ⊚ | 118 ◯ |
| 16 | [symbol] 4 | 68 [symbol] 4 | CC4 | BC-1 | 30 | 117 ⊚ | 118 ◯ | 117 ⊚ | 117 ⊚ | 117 ⊚ |
| 17 | [symbol] 5 | 69 [symbol] 5 | CC5 | BC-1 | 30 | 118 ◯ | 118 ◯ | 118 ◯ | 117 ⊚ | 117 ⊚ |
| 18 | [symbol] 6 | 70 [symbol] 6 | CC6 | BC-2 | 20 | 117 ⊚ | 118 ◯ | 117 ⊚ | 117 ⊚ | 117 ⊚ |
| 19 | [symbol] 7 | 71 [symbol] 7 | CC7 | BC-2 | 15 | 118 ◯ | 118 ◯ | 118 ◯ | 117 ⊚ | 118 ◯ |
| 20 | [symbol] 8 | 72 [symbol] 8 | CC8 | BC-2 | 20 | 117 ⊚ | 118 ◯ | 118 ◯ | 118 ◯ | 118 ◯ |
| 21 | [symbol] 9 | 73 [symbol] 9 | CC9 | BC-2 | 20 | 118 ◯ | 118 ◯ | 118 ◯ | 117 ⊚ | 118 ◯ |
| 22 | [symbol] 10 | 74 [symbol] 10 | CC10 | BC-2 | 20 | 118 ◯ | 120 Δ | 118 ◯ | 117 ⊚ | 118 ◯ |
| 23 | [symbol] 11 | 75 [symbol] 11 | CC11 | BC-2 | 20 | 117 ⊚ | 118 ◯ | 117 ⊚ | 117 ⊚ | 117 ⊚ |
| 24 | [symbol] 12 | 76 [symbol] 12 | CC12 | BC-2 | 20 | 117 ⊚ | 118 ◯ | 118 ◯ | 117 ⊚ | 118 ◯ |
| 25 | [symbol] 13 | 77 [symbol] 13 | CC13 | BC-2 | 20 | 118 ◯ | 118 ◯ | 117 ⊚ | 118 ◯ | 118 ◯ |
| 26 | [symbol] 14 | 78 [symbol] 14 | CC14 | BC-1 | 20 | 117 ⊚ | 118 ◯ | 117 ⊚ | 117 ⊚ | 117 ⊚ |
| 27 | [symbol] 15 | 79 [symbol] 15 | CC15 | BC-2 | 20 | 117 ⊚ | 118 ◯ | 117 ⊚ | 117 ⊚ | 117 ⊚ |
| 28 | [symbol] 16 | 80 [symbol] 16 | CC16 | BC-2 | 20 | 117 ⊚ | 118 ◯ | 117 ⊚ | 117 ⊚ | 117 ⊚ |
| 29 | [symbol] 17 | 81 [symbol] 17 | CC17 | BC-2 | 20 | 118 ◯ | 118 ◯ | 118 ◯ | 117 ⊚ | 118 ◯ |
| 30 | [symbol] 18 | 82 [symbol] 18 | CC18 | BC-2 | 20 | 118 ◯ | 118 ◯ | 118 ◯ | 117 ⊚ | 118 ◯ |
| 31 | [symbol] 19 | 83 [symbol] 19 | CC19 | BC-1 | 25 | 117 ⊚ | 118 ◯ | 117 ⊚ | 117 ⊚ | 117 ⊚ |
| 32 | [symbol] 20 | 84 [symbol] 20 | CC20 | BC-1 | 25 | 118 ◯ | 118 ◯ | 117 ⊚ | 117 ⊚ | 118 ◯ |
| 33 | [symbol] 21 | 85 [symbol] 21 | CC21 | BC-1 | 25 | 117 ⊚ | 118 ◯ | 117 ⊚ | 117 ⊚ | 117 ⊚ |
| 34 | [symbol] 22 | 86 [symbol] 22 | CC22 | BC-2 | 20 | 117 ⊚ | 118 ◯ | 117 ⊚ | 117 ⊚ | 117 ⊚ |
| 35 | [symbol] 23 | 87 [symbol] 23 | CC23 | BC-2 | 20 | 117 ⊚ | 118 ◯ | 117 ⊚ | 117 ⊚ | 117 ⊚ |
| 36 | [symbol] 24 | 88 [symbol] 24 | CC24 | BC-2 | 20 | 117 ⊚ | 118 ◯ | 117 ⊚ | 117 ⊚ | 118 ◯ |
| 37 | [symbol] 25 | 89 [symbol] 25 | CC25 | BC-2 | 20 | 118 ◯ | 118 ◯ | 118 ◯ | 117 ⊚ | 118 ◯ |
| 38 | [symbol] 26 | 90 [symbol] 26 | CC26 | BC-2 | 20 | 118 ◯ | 118 ◯ | 118 ◯ | 117 ⊚ | 118 ◯ |
| 39 | [symbol] 27 | 91 [symbol] 27 | CC27 | BC-2 | 20 | 117 ⊚ | 118 ◯ | 117 ⊚ | 117 ⊚ | 117 ⊚ |
| 40 | [symbol] 28 | 92 [symbol] 28 | CC28 | BC-2 | 20 | 118 ◯ | 118 ◯ | 118 ◯ | 117 ⊚ | 118 ◯ |
| 41 | [symbol] 29 | 93 [symbol] 29 | CC29 | BC-2 | 20 | 117 ⊚ | 118 ◯ | 117 ⊚ | 117 ⊚ | 117 ⊚ |
| 42 | [symbol] 30 | 94 [symbol] 30 | CC30 | BC-2 | 10 | 118 ◯ | 118 ◯ | 118 ◯ | 117 ⊚ | 118 ◯ |
| 43 | [symbol] 31 | 95 [symbol] 31 | CC31 | BC-2 | 20 | 117 ⊚ | 118 ◯ | 118 ◯ | 117 ⊚ | 117 ⊚ |
| 44 | [symbol] 32 | 96 [symbol] 32 | CC32 | BC-1 | 15 | 118 ◯ | 118 ◯ | 118 ◯ | 118 ◯ | 118 ◯ |
| 45 | [symbol] 33 | 97 [symbol] 33 | CC33 | BC-1 | 20 | 118 ◯ | 118 ◯ | 118 ◯ | 118 ◯ | 118 ◯ |
| 46 | [symbol] 34 | 98 [symbol] 34 | CC34 | BC-2 | 15 | 118 ◯ | 118 ◯ | 118 ◯ | 118 ◯ | 118 ◯ |
| 47 | [symbol] 35 | 99 [symbol] 35 | CC35 | BC-2 | 15 | 118 ◯ | 118 ◯ | 118 ◯ | 118 ◯ | 118 ◯ |
| 48 | [symbol] 36 | 100 [symbol] 36 | CC36 | BC-2 | 15 | 118 ◯ | 118 ◯ | 118 ◯ | 118 ◯ | 118 ◯ |
| 49 | [symbol] 37 | 101 [symbol] 37 | CC37 | BC-1 | 10 | 118 ◯ | 118 ◯ | 118 ◯ | 118 ◯ | 118 ◯ |
| 50 | [symbol] 38 | 102 [symbol] 38 | CC38 | BC-1 | 15 | 118 ◯ | 118 ◯ | 118 ◯ | 118 ◯ | 118 ◯ |
| 51 | [symbol] 39 | 103 [symbol] 39 | CC39 | BC-2 | 15 | 118 ◯ | 118 ◯ | 118 ◯ | 118 ◯ | 118 ◯ |
| 52 | [symbol] 40 | 104 [symbol] 40 | CC40 | BC-2 | 15 | 118 ◯ | 118 ◯ | 118 ◯ | 118 ◯ | 118 ◯ |
| 53 | [symbol] 41 | 105 [symbol] 41 | CC41 | BC-2 | 15 | 118 ◯ | 118 ◯ | 118 ◯ | 118 ◯ | 118 ◯ |
| 54 | [symbol] 42 | 106 [symbol] 42 | CC42 | BC-2 | 15 | 118 ◯ | 118 ◯ | 118 ◯ | 118 ◯ | 118 ◯ |
| 55 | [symbol] 43 | 107 [symbol] 43 | CC43 | BC-1 | 20 | 118 ◯ | 118 ◯ | 118 ◯ | 118 ◯ | 118 ◯ |
| 56 | [symbol] 44 | 108 [symbol] 44 | CC44 | BC-1 | 15 | 118 ◯ | 118 ◯ | 118 ◯ | 118 ◯ | 118 ◯ |
| 57 | [symbol] 45 | 109 [symbol] 45 | CC45 | BC-2 | 20 | 118 ◯ | 118 ◯ | 118 ◯ | 118 ◯ | 118 ◯ |
| 58 | [symbol] 1 | 110 [symbol] 46 | CC46 | BC-2 | 20 | 119 X | 119 X | 119 X | 119 X | 120 Δ |
| 59 | [symbol] 2 | 111 [symbol] 47 | CC47 | BC-1 | 25 | 119 X | 119 X | 119 X | 119 X | 120 Δ |
| 60 | [symbol] 3 | 112 [symbol] 48 | CC48 | BC-2 | 25 | 120 Δ | 119 X | 119 X | 120 Δ | 120 Δ |
| 61 | [symbol] 4 | 113 [symbol] 49 | CC49 | BC-1 | 20 | 119 X | 119 X | 119 X | 119 X | 120 Δ |
| 62 | [symbol] 5 | 114 [symbol] 50 | CC50 | BC-2 | 20 | 119 X | 119 X | 119 X | 119 X | 119 X |
| 63 | [symbol] 6 | 115 [symbol] 51 | CC51 | BC-1 | 20 | 119 X | 119 X | 118 ◯ | 119 X | 119 X |
| 64 | [symbol] 7 | 116 [symbol] 52 | CC52 | BC-2 | 20 | 119 X | 119 X | 118 ◯ | 119 X | 119 X |

| Number | Source | Translation |
|---|---|---|
| 1 | [symbol] | Example |
| 2 | [symbol] | Test plate |
| 3 | [symbol] | Clear coating composition (CC) |
| 4 | [symbol] | Aqueous first colored |
| | (BC1) | coating composition (BC1) |
| 5 | [symbol] | Type |
| 6 | [symbol] | Dry film thickness (μm) |
| 7 | [symbol] | Chipping resistance |
| 8 | [symbol] | Gasoline resistance |
| 9 | [symbol] | Water resistance |
| 10 | [symbol] | Blistering |
| 11 | [symbol] | Adhesion |
| 12 | [symbol] | Recoat adhesion |
| 13 | [symbol] 1 | Example 1 |
| 14 | [symbol] 2 | Example 2 |
| 15 | [symbol] 3 | Example 3 |
| 16 | [symbol] 4 | Example 4 |
| 17 | [symbol] 5 | Example 5 |
| 18 | [symbol] 6 | Example 6 |
| 19 | [symbol] 7 | Example 7 |
| 20 | [symbol] 8 | Example 8 |
| 21 | [symbol] 9 | Example 9 |
| 22 | [symbol] 10 | Example 10 |
| 23 | [symbol] 11 | Example 11 |
| 24 | [symbol] 12 | Example 12 |
| 25 | [symbol] 13 | Example 13 |
| 26 | [symbol] 14 | Example 14 |
| 27 | [symbol] 15 | Example 15 |
| 28 | [symbol] 16 | Example 16 |
| 29 | [symbol] 17 | Example 17 |
| 30 | [symbol] 18 | Example 18 |
| 31 | [symbol] 19 | Example 19 |
| 32 | [symbol] 20 | Example 20 |
| 33 | [symbol] 21 | Example 21 |
| 34 | [symbol] 22 | Example 22 |
| 35 | [symbol] 23 | Example 23 |
| 36 | [symbol] 24 | Example 24 |
| 37 | [symbol] 25 | Example 25 |
| 38 | [symbol] 26 | Example 26 |
| 39 | [symbol] 27 | Example 27 |
| 40 | [symbol] 28 | Example 28 |
| 41 | [symbol] 29 | Example 29 |
| 42 | [symbol] 30 | Example 30 |
| 43 | [symbol] 31 | Example 31 |
| 44 | [symbol] 32 | Example 32 |
| 45 | [symbol] 33 | Example 33 |
| 46 | [symbol] 34 | Example 34 |
| 47 | [symbol] 35 | Example 35 |
| 48 | [symbol] 36 | Example 36 |
| 49 | [symbol] 37 | Example 37 |
| 50 | [symbol] 38 | Example 38 |
| 51 | [symbol] 39 | Example 39 |
| 52 | [symbol] 40 | Example 40 |
| 53 | [symbol] 41 | Example 41 |
| 54 | [symbol] 42 | Example 42 |
| 55 | [symbol] 43 | Example 43 |
| 56 | [symbol] 44 | Example 44 |
| 57 | [symbol] 45 | Example 45 |
| 58 | [symbol] 1 | Comparative Example 1 |
| 59 | [symbol] 2 | Comparative Example 2 |
| 60 | [symbol] 3 | Comparative Example 3 |
| 61 | [symbol] 4 | Comparative Example 4 |
| 62 | [symbol] 5 | Comparative Example 5 |
| 63 | [symbol] 6 | Comparative Example 6 |
| 64 | [symbol] 7 | Comparative Example 7 |
| 65 | [symbol] 1 | Test Plate 1 |
| 66 | [symbol] 2 | Test Plate 2 |
| 67 | [symbol] 3 | Test Plate 3 |
| 68 | [symbol] 4 | Test Plate 4 |
| 69 | [symbol] 5 | Test Plate 5 |
| 70 | [symbol] 6 | Test Plate 6 |
| 71 | [symbol] 7 | Test Plate 7 |
| 72 | [symbol] 8 | Test Plate 8 |
| 73 | [symbol] 9 | Test Plate 9 |
| 74 | [symbol] 10 | Test Plate 10 |
| 75 | [symbol] 11 | Test Plate 11 |
| 76 | [symbol] 12 | Test Plate 12 |
| 77 | [symbol] 13 | Test Plate 13 |
| 78 | [symbol] 14 | Test Plate 14 |
| 79 | [symbol] 15 | Test Plate 15 |
| 80 | [symbol] 16 | Test Plate 16 |
| 81 | [symbol] 17 | Test Plate 17 |
| 82 | [symbol] 18 | Test Plate 18 |
| 83 | [symbol] 19 | Test Plate 19 |
| 84 | [symbol] 20 | Test Plate 20 |
| 85 | [symbol] 21 | Test Plate 21 |
| 86 | [symbol] 22 | Test Plate 22 |
| 87 | [symbol] 23 | Test Plate 23 |
| 88 | [symbol] 24 | Test Plate 24 |
| 89 | [symbol] 25 | Test Plate 25 |
| 90 | [symbol] 26 | Test Plate 26 |
| 91 | [symbol] 27 | Test Plate 27 |
| 92 | [symbol] 28 | Test Plate 28 |
| 93 | [symbol] 29 | Test Plate 29 |
| 94 | [symbol] 30 | Test Plate 30 |
| 95 | [symbol] 31 | Test Plate 31 |
| 96 | [symbol] 32 | Test Plate 32 |
| 97 | [symbol] 33 | Test Plate 33 |
| 98 | [symbol] 34 | Test Plate 34 |
| 99 | [symbol] 35 | Test Plate 35 |
| 100 | [symbol] 36 | Test Plate 36 |
| 101 | [symbol] 37 | Test Plate 37 |
| 102 | [symbol] 38 | Test Plate 38 |
| 103 | [symbol] 39 | Test Plate 39 |
| 104 | [symbol] 40 | Test Plate 40 |
| 105 | [symbol] 41 | Test Plate 41 |
| 106 | [symbol] 42 | Test plate 42 |
| 107 | [symbol] 43 | Test Plate 43 |
| 108 | [symbol] 44 | Test Plate 44 |
| 109 | [symbol] 45 | Test Plate 45 |
| 110 | [symbol] 46 | Test Plate 46 |
| 111 | [symbol] 47 | Test Plate 47 |
| 112 | [symbol] 48 | Test Plate 48 |
| 113 | [symbol] 49 | Test Plate 49 |
| 114 | [symbol] 50 | Test Plate 50 |
| 115 | [symbol] 51 | Test Plate 51 |
| 116 | [symbol] 52 | Test plate 52 |
| 117 | ⊚ | very good |
| 118 | ◯ | good |
| 119 | X | poor |
| 120 | Δ | fair |

### Evaluation

The following coating film performance tests were conducted on Test Plates 1 to 52 prepared as described above. The evaluation results are also listed in Table 6. Note that the visual evaluation results were the average of the observational results of 20 evaluators.

### <Chipping Resistance>

The test plate was mounted on a sample holder of a Gravel Test Instrument JA-400 (trade name, made by Suga Test Instruments Co., Ltd.) and, at −20° C., 50 g of crushed granite, with a No. 7 particle size, was struck the test plate at an angle of 45 degrees, by way of compressed air at 0.39 MPa (4 kgf/cm2), from a distance of 30 cm from the test plate. Subsequently, the resulting test plate was washed with water and dried, and a cloth adhesive tape (made by NICHIBAN Co., Ltd.) was affixed to the coated surface, and after peeling this off, the occurrence of damages on the coating film on the test plate was visually observed and evaluated according to the following criteria.
very good: The sizes of the damages are very small, and the electrodeposition coating film surface and the base steel plate are not exposed.
good: The sizes of the damages are small, and the electrodeposition coating film surface and the base steel plate are not exposed.
fair: The sizes of the damages are small, but the electrodeposition coating film surface and the base steel plate are exposed.
poor: The sizes of the damages are quite large, and the base steel plate is also greatly exposed.

### <Gasoline Resistance>

The test plate was immersed in regular unleaded gasoline (No. 2 defined in JIS K2202: 2012) at 20° C. for 24 hours, and the appearance was visually observed and evaluated according to the following criteria.
good: No problems were found.
fair: Slight problems such as yellowing and blistering were found.
poor: Problems such as yellowing and blistering were found.

### <Water Resistance Test: Blistering>

The test plate was immersed in warm water at 40° C. for 10 days, taken out and dried, and then the coated surface was visually observed, and the occurrence of blisters was evaluated using the following criteria.
very good: No blistering occurred.
good: The area where blisters occurred is no greater than 10% of the total area.
fair: The area where blisters occurred is 11% to 30% of the total area.
poor: The area where blisters occurred is 31% or more of the total area.

### <Water Resistance Test: Adhesion>

The test plate was immersed in warm water at 40° C. for 10 days, then taken out and dried. Subsequently, cut-lines were made in the coated surface of the test plate with a cutter so as to reach the substrate, making 100 squares of 2 mm×2 mm in size, then adhesive cellophane tape was affixed to the surface, and this was suddenly peeled off at 45°, at 20° C. The evaluation was performed based on the number of remaining pieces of coating film in the grid, according to the following criteria.
very good: 100 pieces (no peeling)
good: 99 pieces (some peeling)
fair: 51 to 98
poor: no greater than 50

### <Recoat Adhesion Test>

The test plate was left at room temperature for 7 days, and the same coating was recoated on the coated surface under the same conditions and cured. That is to say, in Example 1, a multilayer coating film was formed which was obtained by sequentially applying an aqueous first colored coating composition BC1-1, an aqueous one-part type second colored coating composition BC2-1, and a clear coating composition CC1, and heating, and this was left at room temperature for 7 days; then, on the surface thereof (on the clear coating film obtained from the clear coating composition CC1), recoating was performed with the same materials, which is to say, the aqueous first colored coating composition BC1-1, the aqueous one-part type second colored coating composition BC2-1, and the clear coating composition CC1, and heating was performed, to form a multilayer coating film.

The laminate of multilayer coating films obtained in this manner was left at room temperature for 3 days, then the same adhesion test as above was conducted, the number of remaining pieces of coating film was found, and the evaluation was made according to the following criteria.
very good: 100 pieces (no peeling)
good: 99 pieces (some peeling)
fair: 51 to 98
poor: no greater than 50

The invention made by the present inventors has been described above in concrete terms based on embodiments but, needless to say, the present invention is not limited to the embodiments described above, and various modifications can be made within a scope that does not depart from the gist thereof.

### EXPLANATION OF THE REFERENCE NUMERALS

BC1-ncd1, BC1-ncd2, BC1-ncd3, BC1-ncd4 uncured first colored coating film
BC2-ncd1, BC2-ncd2, BC2-ncd3, BC2-ncd4 uncured second colored coating film
CC-ncd1, CC-ncd2, CC-ncd3, CC-ncd4 uncured clear coating film
BC1-cd1, BC1-cd2, BC1-cd3, BC1-cd4 cured first colored coating film
BC2-cd1, BC2-cd2, BC2-cd3, BC2-cd4 cured second colored coating film
CC-cd1, CC-cd2, CC-cd3, CC-cd4 cured clear coating film
D unsaturated fatty acid ester polyol

1. A method for forming a multilayer coating film, comprising:
a step (1) of coating an aqueous first colored coating composition (BC1) onto an object to be coated to form an uncured first colored coating film;
a step (2) of coating an aqueous one-part type second colored coating composition (BC2) onto the uncured first colored coating film obtained in step (1) to form an uncured second colored coating film;
a step (3) of coating a clear coating composition (CC) onto the uncured second colored coating film obtained in step (2) to form an uncured clear coating film, wherein
the clear coating composition (CC) includes a hydroxyl group-containing acrylic resin (A1),
an isocyanate curing agent (A2), and
an unsaturated fatty acid ester polyol (D) having at least two hydroxyl groups in one molecule,
and the distance Ra between the solubility parameters in Hansen space of the hydroxyl group-containing acrylic resin (A1) and the solubility parameters in Hansen space of the unsaturated fatty acid ester polyol (D) is 4.0 or less; and
a step (4) of simultaneously curing the uncured first colored coating film, the uncured second colored coating film, and the uncured clear coating film, formed in steps (1) to (3), by heating at 70 to 100° C.

2. The method for forming a multilayer coating film as claimed in claim 1, wherein the amount (solids content) of the unsaturated fatty acid ester polyol (D) blended is 3 to 20 mass %, with respect to the total mass of the solids contents of all of the resin components included in the clear coating composition (CC).

3. The method for forming a multilayer coating film as claimed in claim 1, wherein the hydroxyl value of the hydroxyl group-containing acrylic resin (A1) is within the range of 80 to 200 mg KOH/g.

4. The method for forming a multilayer coating film as claimed in claim 1, wherein the hydroxyl group-containing acrylic resin (A1) has a mass average molecular weight of 3,000 to 30,000.

5. The method for forming a multilayer coating film as claimed in claim 1, wherein the clear coating composition (CC) includes a urethane curing catalyst (E).

6. The method for forming a multilayer coating film as claimed in claim 1, wherein the first colored coating film has a dry film thickness of 4 to 30 μm.

7. The method for forming a multilayer coating film as claimed in claim 1, wherein the aqueous first colored coating composition (BC1) includes a carboxyl group-containing resin (B1) and a carbodiimide group-containing curing agent (B2),
and the clear coating composition (CC) includes isocyanate groups in the isocyanate curing agent (A2) at a ratio of 0.8 to 1.5 equivalents per 1 equivalent of hydroxyl groups in the hydroxyl group-containing acrylic resin (A1).

8. The method for forming a multilayer coating film as claimed in claim 1, wherein the clear coating composition (CC) includes isocyanate groups in the isocyanate curing agent (A2) at a ratio of 1.5 to 3.0 equivalents per 1 equivalent of hydroxyl groups in the hydroxyl group-containing acrylic resin (A1), and the isocyanate curing agent (A2) includes a diisocyanate dimer (A2-1) and a diisocyanate trimer or higher compound (A2-2) at a solids-content mass ratio within a range of 10/90 to 40/60.

9. The method for forming a multilayer coating film as claimed in claim 1, wherein the clear coating composition (CC) includes a 3-isocyanatopropyltrialkoxysilane compound (A3).

10. The method for forming a multilayer coating film as claimed in claim 9, wherein the amount (solids content) of the 3-isocyanatopropyltrialkoxysilane compound (A3) blended is 2 to 50 mass %, with respect to the total mass of the solids contents of all of the resin components included in the clear coating composition (CC).

11. A clear coating composition (CC) for forming a clear coating film used for forming a multilayer coating film by simultaneously curing an uncured first colored coating film formed from an aqueous first colored coating composition (BC1),
an uncured second colored coating film formed from an aqueous one-part type second colored coating composition (BC2) provided on the uncured first colored coating film,
and the uncured clear coating film provided on the uncured second colored coating film, wherein:
the clear coating composition (CC) includes
a hydroxyl group-containing acrylic resin (A1),
an isocyanate curing agent (A2), and
an unsaturated fatty acid ester polyol (D) having at least two hydroxyl groups in one molecule;
the distance Ra between the solubility parameters in Hansen space of the hydroxyl group-containing acrylic resin (A1) and the solubility parameters in Hansen space of the unsaturated fatty acid ester polyol (D) is 4.0 or less; and
the uncured first colored coating film, the uncured second colored coating film, and the uncured clear coating film are cured by heating at 70 to 100° C.

12. The clear coating composition (CC) as claimed in claim 11, wherein the amount (solids content) of the unsaturated fatty acid ester polyol (D) blended is 3 to 20 mass %, with respect to the total mass of the solids contents of all of the resin components included in the clear coating composition (CC).

13. The clear coating composition as claimed in claim 11, wherein the aqueous first colored coating composition (BC1) includes a carboxyl group-containing resin (B1) and a carbodiimide group-containing curing agent (B2),
and the clear coating composition (CC) includes isocyanate groups in the isocyanate curing agent (A2) at a ratio of 0.8 to 1.5 equivalents per 1 equivalent of hydroxyl groups in the hydroxyl group-containing acrylic resin (A1).

14. The clear coating composition (CC) as claimed in claim 11, wherein the clear coating composition (CC) includes isocyanate groups in the isocyanate curing agent (A2) at a ratio of 1.5 to 3.0 equivalents per 1 equivalent of hydroxyl groups in the hydroxyl group-containing acrylic resin (A1) and the isocyanate curing agent (A2) includes a diisocyanate dimer (A2-1) and a diisocyanate trimer or higher compound (A2-2) at a solids-content mass ratio within a range of 10/90 to 40/60.

15. The clear coating composition (CC) as claimed in claim 11, wherein the clear coating composition (CC) includes a 3-isocyanatopropyltrialkoxysilane compound (A3).

16. The clear coating composition (CC) as claimed in claim 15, wherein the amount (solids content) of the 3-isocyanatopropyltrialkoxysilane compound (A3) blended is 2 to 50 mass %, with respect to the total mass of the solids contents of all of the resin components included in the clear coating composition (CC).
